(19) United States
(12) Patent Application Publication
(10) Pub. No.: US 2026/0203275 A1
(43) Pub. Date: Jul. 16, 2026

(54) Methods, Apparatuses, Devices and Computer Programs for Creating, Updating or Using a Data Structure With At Least One Semantic Descriptor

(71) Applicant: Intel Corporation, Santa Clara, CA (US)

(72) Inventor: Robert L. VAUGHN, Portland, OR (US)

(21) Appl. No.: 19/398,770

(22) Filed: Nov. 24, 2025

(51) Int. Cl. G06F 16/23; G06F 40/30

(52) U.S. Cl. CPC G06F 16/2365; G06F 40/30

(57) ABSTRACT

Some aspects of the present disclosure relate to a non-transitory computer-readable medium storing instructions that, when executed by one or more processing circuitries, cause the one or more processing circuitries to perform a method for a computer system, the method comprising obtaining (110) a set of data, determining (120) at least one semantic descriptor characterizing a current state of the set of data, determining (130) whether the set of data is associated with a data structure comprising at least one semantic descriptor characterizing a previous state of the set of data, in response to a negative determination, creating (150) a new data structure comprising the determined at least one semantic descriptor characterizing the current state of the set of data, in response to a positive determination, computing (160) a combination of (i) a decayed version of the at least one semantic descriptor characterizing the previous state of the set of data and (ii) the at least one semantic descriptor characterizing the current state of the set of data, and updating (165) the data structure based on the combination.

### BACKGROUND

Machine learning and artificial intelligence are an inherently data-driven field. During development and evolution of machine learning models, training data sets are created, merged, augmented, refined etc. Multiple training stages are used to train various checkpoints of machine learning models, trying out different approaches with the goal of improving the performance (or reducing the computational complexity) of the respective machine learning models. Today, across the industry, teams cannot quantify “how we got here” from two checkpoints or training data sets alone: hashes are brittle to benign changes, logs/graphs are bulky or missing, and audits often lack a portable signal of ordered influence.

There are various approaches and software tools for determining a relationship between two versions of a data set, such as a data set used in the machine learning flow. For example, the “tracking” functionality of MLflow logs parameters, metrics, artifacts, and code versions and lets teams compare runs via a backend UI. While this enables tracking the evolution of a machine learning model, the entire run history is needed for this purpose. Given two isolated versions, their lineage cannot be computed. TensorFlow Extended (TFX)—ML Metadata (MLMD) records artifacts, executions, and events to build lineage graphs, but relies on a metadata store/graph traversal. It also does not enable determining the lineage between two isolated data sets. OpenLineage/Marquez standardizes collection of job/dataset/run metadata and visualizes lineage, but presumes a service and event stream. W3C PROV (PROV-DM/PROV-O) provides a general provenance data model/ontology for graph representations. DVC (Data Version Control) versions data/models with Git-like commits and pipelines, but depends on repository state (hashes+logs). Pachyderm offers version-controlled data pipelines with lineage tracking inside its platform. Git-style content hashes provide integrity and content addressability, but are intentionally brittle to small changes, are not order-sensitive, and cannot express partial ancestry between checkpoints. SimHash (Locality-Sensitive Hashing) is suitable for near-duplicate content detection, but not designed to encode ordered process lineage or to quantify how much an earlier state contributes to a later checkpoint.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, and of a computer system comprising such an apparatus or device;

FIG. 1b shows a flowchart of an example of a method for a computer system;

FIG. 2a shows a schematic diagram of an example of an apparatus or device for a computer system, and of a computer system comprising such an apparatus or device;

FIG. 2b shows a flowchart of an example of a method for a computer system;

FIG. 3 shows a graph used to illustrate traceability across mixed, converted, and merged datasets over thousands of steps;

FIG. 4 shows a sequence diagram for one iteration;

FIG. 5 shows a spreadsheet-based example;

FIG. 6 broken into partial views 6A, 6B, and 6C, shows a Perl script of a minimal working core of an example of the proposed concept;

FIG. 7 broken into partial views 7A to 7F, shows a Python script of an example of the proposed concept;

FIG. 8 broken into partial views 8A to 8G, shows an example of the Python script;

FIG. 9 shows an example of a JSON (JavaScript Object Notation) representation of a capsule including a SimHash; and

FIG. 10 shows a block diagram of an example computer system.

### DETAILED DESCRIPTION

Some examples are now described in more detail with reference to the enclosed figures. However, other possible examples are not limited to the features of these embodiments that are described in detail. Other examples may include modifications of the features as well as equivalents and alternatives to the features. Furthermore, the terminology used herein to describe certain examples should not be restrictive of further possible examples.

Throughout the description of the figures, the same or similar reference numerals refer to the same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B, as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an”, and “the”, is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the element items so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource, are used interchangeably, and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

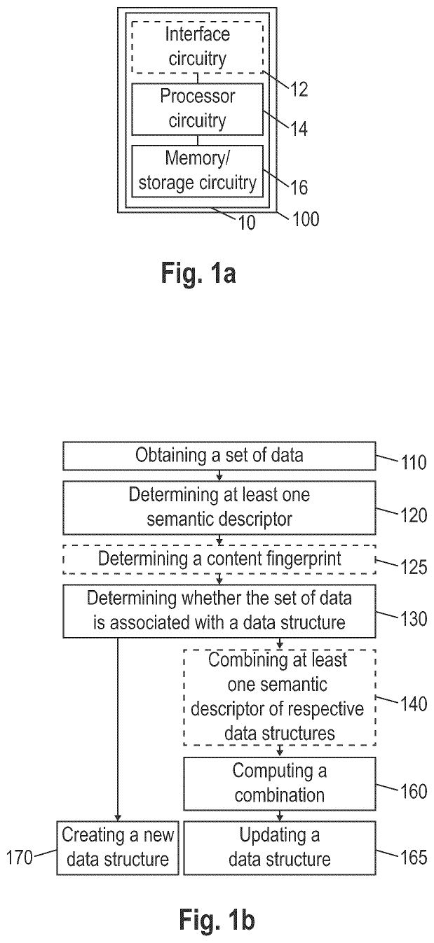

FIG. 1a shows a schematic diagram of an example of an apparatus 10 or device 10 for a computer system 100, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises (optional) interface circuitry 12, processor circuitry 14, and memory/storage circuitry 16. For example, the processor circuitry 14 may be coupled with the interface circuitry 12 and/or with the memory/storage circuitry 16. For example, the processor circuitry 14 may provide the functionality of the apparatus in conjunction with the interface circuitry 12 (for communicating with other entities inside or outside the computer system 100) and the memory/storage circuitry 16 (for storing information, such as machine-readable instructions, a data structure, or a data set). Likewise, the device 10 may comprise means for providing the functionality of the device 10. For example, the means may be configured to provide the functionality of the device 10. The components of the device 10 are defined as component means, which may correspond to, or be implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

The processor circuitry 14 or means for processing 14 is to obtain a set of data. The processor circuitry 14 or means for processing 14 is to determine at least one semantic descriptor characterizing a current state of the set of data. The processor circuitry 14 or means for processing 14 is to determine whether the set of data is associated with a data structure comprising at least one semantic descriptor characterizing a previous state of the set of data. The processor circuitry 14 or means for processing 14 is to, in response to a negative determination, create a new data structure comprising the determined at least one semantic descriptor characterizing the current state of the set of data. The processor circuitry 14 or means for processing 14 is to in response to a positive determination, compute a combination of (i) a decayed version of the at least one semantic descriptor characterizing the previous state of the set of data and (ii) the at least one semantic descriptor characterizing the current state of the set of data, and update the data structure based on the combination.

FIG. 1b shows a flowchart of an example of a corresponding method for a computer system, such as the computer system 100 of FIG. 1a. For example, the method may be performed by the computer system 100, e.g., by the apparatus 10 or device 10 of the computer system 100. The method comprises obtaining 110 the set of data. The method comprises determining 120 the at least one semantic descriptor characterizing the current state of the set of data. The method comprises determining 130 whether the set of data is associated with a data structure comprising at least one semantic descriptor characterizing the previous state of the set of data. The method comprises, in response to a negative determination, creating 150 a new data structure comprising the determined at least one semantic descriptor characterizing the current state of the set of data. The method comprises, in response to a positive determination, computing 160 the combination of (i) the decayed version of the at least one semantic descriptor characterizing the previous state of the set of data and (ii) the at least one semantic descriptor characterizing the current state of the set of data, and updating 165 the data structure based on the combination.

In the following, the features of the computer system 100, apparatus 10, device 10, and the corresponding method will be introduced in more detail with reference to the apparatus 10 and method. Features discussed in connection with the apparatus 10 or method may likewise be included in the corresponding device 10 or computer system 100.

Various examples of the present disclosure are based on the finding that tracking the evolution of a data set in a structured, computationally efficient manner is a persistent challenge in machine-learning workflows. While there are other approaches, these approaches rely on keeping a detailed log of all activities. Using these approaches, it is not possible to determine a lineage between two states of a data set without having access to the detailed log of all activities. In particular, it is not possible with the data that is stored in or alongside the respective data sets. The present disclosure relates to a technique for maintaining a compact history of semantic descriptors that characterize successive states of a data set, while automatically applying exponential decay to older states so that recent changes dominate the current representation. This improves the ability of downstream processes to assess data lineage, verify reproducibility. For example, in the context of machine learning, the proposed concept facilitates making informed decisions about the evolution of data sets (e.g., trained models or training data) without incurring large storage or computational overhead. In the context of the present disclosure, decay may be defined as the rate of decrease of a quantity proportional to its current value.

The proposed concept starts with the set of data, which is also denoted “artifact” in the context of the present disclosure. A set of data is any serialized object one wants lineage for, such as a model checkpoint, dataset snapshot, preprocessing output, configuration bundle, file, folder of files etc. This set of data has semantic properties. The semantic properties may not represent the content of the set of data, but rather metadata characterizing the set of data. Thus, the at least one semantic descriptor is based on at least one semantic property of the set of data, i.e., based on metadata that describe the type of data and provenance of data in the set of data, without being based on the concrete content of the data. In other words, the at least one semantic descriptor may be based on metadata characterizing the set of data. For example, the at least one semantic descriptor may be based on at least one of a version information characterizing the set of data, an origin of the set of data, a quality measure characterizing the set of data, a data type of the set of data, an ownership of the set of data, a timestamp of the set of data, an intended usage of the set of data, a licensing term of the set of data, an authorship of the set of data, or a format of the set of data etc. To provide a richer characterization of data states, the method may employ a composite descriptor that is based on a plurality of semantic descriptors that respectively characterize a plurality of aspects (such as version information, origin of the set of data, quality measure, data type, ownership, timestamp, intended usage, licensing term, authorship or format of the set of data) of the state of the set of data. By aggregating multiple aspects into a single descriptor, the proposed concept yields a more holistic representation that can capture various aspects of the set of data. For example, to support machine-learning workflows (i.e., the set of data relates to machine learning), the semantic descriptor may represent aspects such as dataset version, dataset size, machine-learning stack version, augmentation profile, optimizer used, or learning rate. These descriptors directly inform training reproducibility and enable automated selection of appropriate model configurations.

The semantic properties of the set of data, at a current state of the set of data, are now used to compute the at least one semantic descriptor characterizing the current state of the set of data. In the context of the present disclosure, this at least one semantic descriptor is also denoted as “in_byte”. It is calculated from the semantic properties of the set of data. For example, at the beginning, a fixed set of semantic properties (also denoted “semantic fields”) to be represented by the at least one semantic descriptor is set. For example, the data structure may have a fixed maximal size and a fixed number of semantic descriptors (representing the fixed set of semantic properties) for each state. This determinism simplifies system provisioning and ensures predictable memory consumption. For example, a fixed number of semantic fields B (e.g., 8 or 16) may be chosen. These semantic fields may include numbers, strings etc. that characterize the current state of the set of data. To represent them in a descriptor, the semantic properties may be mapped (individually) to numbers, e.g., numbers in the range of [0 . . . 255] that is representable by a byte. For example, ASCII letters (which are representable by 62 different numbers) may be mapped into the [0 . . . 255] space. Similarly, numbers may be mapped into the space as well (e.g., by defining a minimal and maximal number for that semantic property and scaling the number accordingly, such that the minimal number would yield 0 and the maximal number would yield 255). In the context of this document, this process is called “ordinalization”.

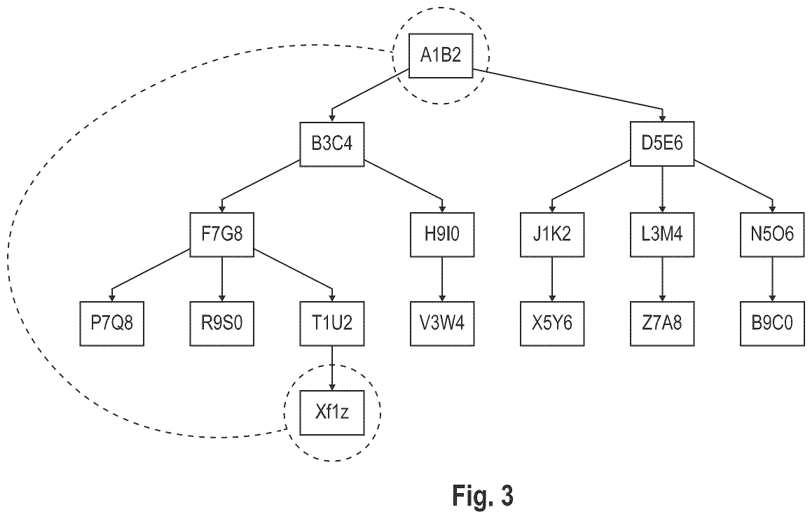

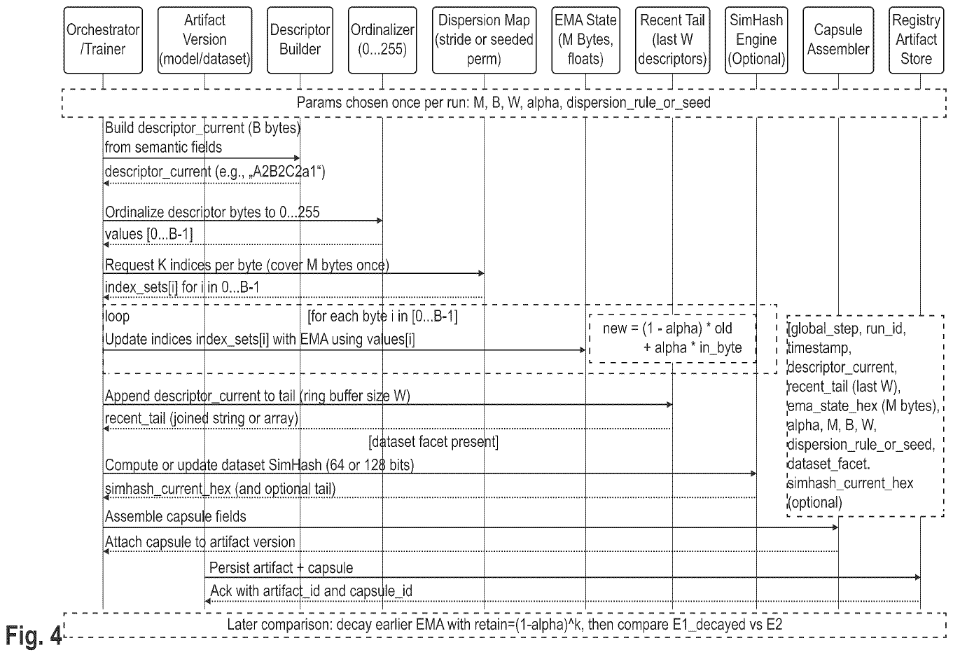

In the examples given in connection with FIGS. 3 to 9, a composite descriptor is generated based on a plurality of individual descriptors each representing a semantic field. In a simple implementation, this may be done by concatenating the individual descriptors. For example, if B=8 semantic fields and each semantic field is represented by a semantic descriptor having 16 bytes, a 128 byte composite descriptor can be generated by concatenating the 8 16-byte descriptors into 128 bytes. To balance the influence of individual descriptors, the method may determine the composite descriptor such that the impact of the individual semantic descriptors of the plurality of semantic descriptors is dispersed across the composite descriptor. This can be done by using a “stride” technique, in which byte i of a descriptor j of B descriptors is mapped to byte (i·B)+j of the composite descriptor. Alternatively, a seeded permutation can be used, in which, at the beginning a mapping between individual descriptor bytes and the composite descriptor is calculated based on a seed. By dispersing the influence, the proposed concept mitigates the dominance of any single attribute and enhances the stability of the overall descriptor.

The next operation depends on whether there is already a data structure (or “capsule”) stored with (or otherwise associated with) the set of data. If there is no data structure present, it is created anew. Thus, a new data structure comprising the determined at least one semantic descriptor characterizing the current state of the set of data is created. In some cases, the at least one semantic descriptor characterizing the current state of the set of data may be included as is into the new data structure. In some other cases, it may be adjusted using the decay mechanism. In this case, an empty/default (composite) semantic descriptor may be used as a starting point, which may be combined with the at least one semantic descriptor characterizing the current state of the set of data in line with the combination used for the case of updating the at least one semantic descriptor of an existing data structure. For example, the at least one semantic descriptor characterizing the current state of the set of data may be (bytewise) multiplied by a decay parameter alpha and added to the empty/default (composite) semantic descriptor.

If there is an existing data structure, it is updated using the at least one semantic descriptor characterizing the current state of the set of data. In particular, the data structure is updated with a combination of (i) the decayed version of the at least one semantic descriptor characterizing the previous state of the set of data and (ii) the at least one semantic descriptor characterizing the current state of the set of data. To decay the at least one semantic descriptor characterizing the previous state of the set of data, an exponential moving average (EMA) may be calculated using a decay parameter (alpha/α). In other words, the decayed version may be based on an exponentially decaying version of semantic descriptors representing a plurality of previous states. The decay parameter allows system operators to control how rapidly older information is diminished, thereby tailoring the proposed concept to specific application requirements. In particular, the decayed version of a semantic descriptor may be calculated using (1−−α)^{k}*Eₚᵣₑᵥᵢₒᵤₛ, where alpha is the decay parameter, k is the number of updates since the previous state, and Eₚᵣₑᵥᵢₒᵤₛ is the semantic descriptor included in the data structure for the previous state. By applying this formula, the proposed concept implements a mathematically rigorous decay that preserves temporal ordering. This decayed version may be combined with the at least one semantic descriptor characterizing the current state of the set of data by multiplying the at least one semantic descriptor characterizing the current state of the set of data with the decay parameter alpha, and adding the result to the decayed version.

As outlined above, the bytes (or other sets of bits) may each have a specific meaning that can be mapped to the semantic fields. To retain this meaning across updates, the combination may be calculated on a per-byte or per set of bits level. In other words, the at least one semantic descriptor comprises a plurality of sets of bits, with each set of bits representing a number. The decayed version may be computed by applying a mathematical function to each number represented by the respective set of bits. This way, the semantic meaning of the individual bytes can be maintained.

In the proposed concept, (exponential) decay is used to ensure that the semantic descriptors of past states influence the semantic descriptors representing the current state. Decay, in this context, refers to the methods and means of generating and updating a fixed sized data structure that represents that information contained across multiple generations of larger data structures that is able to deterministically reference back to earlier generations in a lesser or decaying basis as new generations are added.

In some cases, sets of data are created by merging/combining previous sets of data. In this case, prior to calculating the combination, the semantic descriptors of the data structures of the two previous sets of data may be combined. In other words, if the set of data is created by combining at least two sets of data that are associated with respective data structures, the processor circuitry 14 may combine the at least one semantic descriptor of the respective data structures to determine the at least one semantic descriptor for the set of data. Accordingly, the method of FIG. 1b may comprise combining 140, the at least one semantic descriptor of the respective data structures to determine the at least one semantic descriptor for the set of data. By integrating descriptors from constituent data, the proposed concept maintains consistent lineage across data fusion operations.

While the at least one semantic descriptor is based on metadata characterizing the set of data, in some cases it may be beneficial to also represent the content of the set of data as part of the capsule. For example, the processor circuitry 14 may determine a content fingerprint of the current state of the set of data (e.g., using a version or derivation of the SimHash algorithm), and include the content fingerprint in the data structure. Accordingly, the method of FIG. 1b may comprise determining 125 the content fingerprint of the current state of the set of data, and including the content fingerprint in the data structure. By embedding a fingerprint, the proposed concept allows determining how much the data within the set of data has changed across states.

In some examples, it may be useful to not only be able to determine how much of a first state of the set of data influences a second state of the set of data, but also to follow the evolution of the at least one semantic descriptor over time (for a limited number of states). Therefore, the data structure may include a recent-tail, in which a limited number of previous versions of the at least one semantic descriptor are stored. In other words, the processor circuitry 14 may create/update the data structure such that the data structure comprises up to a predefined number of sets of semantic descriptors representing up to the predefined number of previous states of the set of data. By fixing the maximal count, the proposed concept guarantees bounded memory usage and predictable performance.

For example, the interface circuitry 12 or means for communicating 12 corresponds to one or more inputs and/or outputs designed to receive and/or transmit information. This information can be in digital (bit) values according to a specified code, whether exchanged within a module, between different modules, or even between modules of distinct entities. For example, the interface circuitry 12 or means for communicating 12 may include interface circuitry configured to handle the reception and/or transmission of such information.

For example, the processing circuitry 14 or means for processing 14 can be implemented using one or more processing units, processing devices, or any means for processing, such as a processor, a computer, or a programmable hardware component equipped with appropriately adapted software. Thus, the described function of the processing circuitry 14 or means for processing 14 can be executed in software, running on one or more programmable hardware components. Such components may include a general-purpose processor, a Digital Signal Processor (DSP), a microcontroller, or more.

For example, the memory/storage circuitry 16 or means for storing information 16 may comprise at least one element of the group of a computer readable storage medium, such as a magnetic or optical storage medium, e.g., a hard disk drive, a flash memory, floppy disk, Random Access Memory (RAM), Programmable Read Only Memory (PROM), Erasable Programmable Read Only Memory (EPROM), an Electronically Erasable Programmable Read Only Memory (EEPROM), or a network storage.

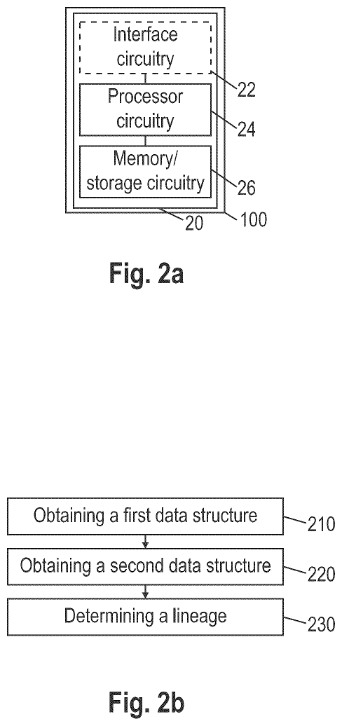

More details and aspects of the apparatus 10, device 10, computer system 100, and method are mentioned in connection with the proposed concept or one or more examples described above or below (e.g. FIG. 2a to 10). The apparatus 10, device 10, computer system 100, and method may comprise one or more additional optional features corresponding to one or more aspects of the proposed concept or one or more examples described above or below.

FIG. 2a shows a schematic diagram of an example of an apparatus 20 or device 20 for a computer system 100, and of a computer system 100 comprising such an apparatus or device. For example, the computer system 100 may comprise the apparatus 10 or device 10 of FIG. 1a, the apparatus 20 or device 20 of FIG. 2a, or both. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises (optional) interface circuitry 22, processor circuitry 24, and memory/storage circuitry 26. For example, the processor circuitry 24 may be coupled with the interface circuitry 22 and/or with the memory/storage circuitry 26. For example, the processor circuitry 24 may provide the functionality of the apparatus, in conjunction with the interface circuitry 22 (for communicating with other entities inside or outside the computer system 100), and the memory/storage circuitry 26 (for storing information, such as machine-readable instructions, a data structure or a data set). Likewise, the device 20 may comprise means for providing the functionality of the device 20. For example, the means may be configured to provide the functionality of the device 20. The components of the device 20 are defined as component means, which may correspond to, or be implemented by, the respective structural components of the apparatus 20. For example, the device 20 of FIG. 2a comprises means for processing 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions, e.g., within the memory or storage circuitry 26 or means for storing information 26.

The processor circuitry 24 or means for processing 24 is to obtain a first data structure comprising at least one semantic descriptor characterizing a first state of a set of data. The processor circuitry 24 or means for processing 24 is to obtain a second data structure comprising at least one semantic descriptor characterizing a second state of the set of data. For example, the respective data structures may be determined or updated using the method, apparatus 10, device 10, or computer system of FIG. 1a or 1b. Accordingly, the at least one semantic descriptor characterizing the second state of the set of data is based on a decayed version of the at least one semantic descriptor characterizing the first state of the set of data. The processor circuitry 24 or means for processing 24 is to determine a lineage between the first state and the second state of the set of data based on the at least one semantic descriptor.

FIG. 2b shows a flowchart of an example of a corresponding method for a computer system, such as the computer system 100 of FIG. 2a (or FIG. 1a). For example, the method may be performed by the computer system 100, e.g., by the apparatus 20 or device 20 of FIG. 2a, or by the apparatus 10 or device 10 of FIG. 1a. The method comprises obtaining 210 the first data structure comprising the at least one semantic descriptor characterizing the first state of the set of data. The method comprises obtaining 220 the second data structure comprising the at least one semantic descriptor characterizing the second state of the set of data. The method comprises determining 230 a lineage between the first state and the second state of the set of data based on the at least one semantic descriptor.

In the following, the features of the computer system 100, apparatus 20, device 20, and the corresponding method will be introduced in more detail with reference to the apparatus 20 and the method. Features discussed in connection with the apparatus 20 or method may likewise be included in the corresponding device 20 or computer system 100.

While the apparatus 10, device 10, and method discussed in connection with FIGS. 1a and 1b relate to the creation and update of the data structure (capsule), the apparatus 20, device 20, and method of FIGS. 2a and 2b relate to their use in tracing the lineage between two states of the set of data. To determine the lineage, first, the at least one semantic descriptor characterizing the “older” state may be decayed to bring it in line with the newer state. For example, using the decay parameter discussed in connection with FIGS. 1a and 1b (as well as 3 to 9), this can be done by calculating state_{t1_to_t2}=(1−α)\hat{ }k*stateₜ₁, where stateₜ₁ is the descriptor of the older state, and state_{t1_to_t2} is the decayed version of the older state. This decayed version can now be compared to the descriptor of the newer state, to determine which bytes, and therefore which semantic fields, have changed between the two states. Thus, the lineage between the two states is the impact of the older state on the newer state.

In some cases, as discussed in connection with FIGS. 1a and 1b, the respective data structures may include a content fingerprint. For example, the processor circuitry 14 may calculate a difference (e.g., hamming distance) between the content fingerprints to determine a similarity between the content of the set of data at the respective states, to gain a fuller picture of the similarities and differences between the two states of the set of data. For example, low distance between the two content fingerprints plus a high similarity of the (composite) descriptors implies continuity. A high similarity between the (composite) descriptors plus a high distance between the content fingerprints suggests process continuity, but the data change.

For example, the interface circuitry 22 or means for communicating 22 corresponds to one or more inputs and/or outputs designed to receive and/or transmit information. This information can be in digital (bit) values according to a specified code, whether exchanged within a module, between different modules, or even between modules of distinct entities. For example, the interface circuitry 22 or means for communicating 22 may include interface circuitry configured to handle the reception and/or transmission of such information.

For example, the processing circuitry 24 or means for processing 24 can be implemented using one or more processing units, processing devices, or any means for processing, such as a processor, a computer, or a programmable hardware component equipped with appropriately adapted software. Thus, the described function of the processing circuitry 24 or means for processing 24 can be executed in software, running on one or more programmable hardware components. Such components may include a general-purpose processor, a Digital Signal Processor (DSP), a microcontroller, or more.

For example, the memory/storage circuitry 26 or means for storing information 26 may comprise at least one element of the group of a computer readable storage medium, such as a magnetic or optical storage medium, e.g., a hard disk drive, a flash memory, floppy disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, computer system 100, and method are mentioned in connection with the proposed concept, or one or more examples described above or below (e.g., FIG. 1a to 1b, 3 to 10). The apparatus 20, device 20, computer system 100, and method may comprise one or more additional optional features corresponding to one or more aspects of the proposed concept, or one or more examples described above or below.

While existing tools solve logging, graph provenance, versioning, or content similarity, none of the existing tools for determining a relationship between two versions of a data set, such as a data set used in the machine learning flow, provides a constant-memory, order-sensitive, exponentially decayed lineage code that can ride with an artifact and support post-hoc attribution from two checkpoints alone, and across many generations, including skipping many generations, to determine relationships between system at iteration (n) versus (y).

The proposed concept provides a method for decay-based lineage encoding of machine-learning artifacts.

This present disclosure is in the domain of machine-learning provenance for models and datasets used across training, fine-tuning, merges, and data updates. Today, across the industry, teams cannot quantify “how we got here” from two checkpoints alone: hashes are brittle to benign changes, logs/graphs are bulky or missing, and audits often lack a portable signal of ordered influence.

The present disclosure proposes a constant-memory, order-sensitive lineage code that updates each step using an exponential moving average over semantic descriptors (optionally paired with a dataset content fingerprint), enabling pairwise attribution without retaining intermediate logs. In the proposed concept, the change process itself, not the artifact, is encoded into a compact, decayed state with explicit recent history, something other tools in hashing and run logging do not provide. The proposed concept provides governance and audit tooling across client/edge/datacenter ML (Machine Learning), enabling defensible model/data marketplaces and federated offerings. The proposed concept provides a foundational algorithmic mechanism for encoding and recovering lineage. A capsule produced at each iteration is fully self-contained and sufficient to determine ancestry relationships across large iteration gaps.

In the proposed concept, lineage is encoded as a fixed-size, order-sensitive state that travels with any machine-learning artifact (model or dataset). A record is produced with each artifact iteration, which is called a “capsule”.

FIG. 3 shows a graph used to illustrate traceability across mixed, converted, and merged datasets over thousands of steps. In FIG. 3, each box is an artifact snapshot (model or dataset). Edges are transformations such as training, fine-tuning, conversion, augmentation, or merges. The circled nodes (A1B2, Xf1z) are the only two snapshots at hand. Because each snapshot carries a small lineage capsule, the relationship between A1B2 and Xf1z can be quantified directly, without consulting intermediate logs or services.

This proposed concept encodes lineage as a deterministic, fixed-size state updated every step by an exponential moving average over semantic descriptors, optionally paired with a dataset content fingerprint (for example, SimHash). The encoding supports both process lineage (non-syntactic, order-sensitive) and content similarity (syntactic), and may yield a numerical score of ancestry when comparing any two snapshots. The same method applies whether artifacts represent whole datasets or models, or finer scopes such as tables, shards, or parameter groups.

Each step in the encoding process may emit a B-byte (where “B” is the size) as semantic descriptor that is called a “generational stream of bytes” (“gen-byte”). Its bytes may be ordinalized (e.g., a character is shifted to an ASCII value), and may be deterministically dispersed to K indices of an M-byte state (stride or seeded permutation), and blended by an exponential moving average (EMA) with coefficient α, optionally alongside a verbatim recent-tail of the last W descriptors (raw gen-byte sets count). The resulting state is an exponentially decayed summary of the change process (not a content hash) that enables pairwise attribution from two snapshots: given a and the step gap k, the expected contribution of the earlier state is (1−α)^{k}·stateₜ₁ and the residual quantifies intervening changes. For datasets, a separate content facet (e.g., SimHash) may be recorded to capture syntactic similarity while the EMA state captures process/semantic lineage. Parameters M, B, α, and W tune capacity and horizon, and merge/ensemble lineage may be represented by coefficient-weighted combinations of parent states inside the same capsule (LID) that holds global_step, descriptor(s), EMA state, α, dispersion seed, and optional content fingerprints.

In the following, a definition is given of the components involved in tracking the lineage (per step). An “Artifact” is any serialized object one wants lineage for, such as a model checkpoint, dataset snapshot, preprocessing output, config bundle. A “Descriptor” (aka gen-byte) is a B-byte per-step code where each byte position has a defined meaning. Example: [0]=dataset version bin, [1]=dataset size bin, [2]=ML stack version, [3]=augmentation profile id, [4]=optimizer family, [5]=learning rate bin, [6]=scheduler id, [7]=misc flag. B is tunable (8, 16, 32). “Ordinalization” maps each descriptor character to a number [0 . . . 255]. For base62 symbols, index 0 . . . 61 may be mapped to 0 . . . 255. “EMA state” is an M-byte fixed state (for example M=64 or 128) that is every step using an exponential moving average. The update rule per touched index may be as follows: new=(1−α)*old+α*in_byte, where α is the EMA coefficient in (0,1). A smaller alpha leads to a longer memory. Retention after k steps is approximately exp(−α*k). A “Dispersion rule” is a deterministic mapping from descriptor byte i to K positions in the EMA state. There may be two options: (1) “Stride”, wherein, with M divisible by B, byte i updates indices i, i+B, i+2B, . . . up to M−B, and (2) “Seeded permutation”, wherein a single permutation of 0 . . . M−1 is built and K=floor(M/B) indices are assigned per descriptor byte. “Recent tail” is the last W descriptors stored verbatim, in order, e.g., as a small ring buffer. Size is W*B bytes. W=0 is allowed. “Dataset content fingerprint” (optional) is a SimHash or similar 64 or 128 bit code for the dataset at this step or commit. This is kept separate from the EMA state. “LID (lineage identifier) capsule” is the record attached to each artifact version. Typical fields are global_step, run_id, descriptor_current, recent_tail (last W descriptors), ema_state_M (hex), alpha, dispersion_seed_or_rule, simhash_current (optional), timestamp, and signatures if you sign the capsule.

In the following, an example use case is described. In the example, Alice is an ML engineer training a speech model. Bob is a data steward maintaining the training corpus. At (1), Bob rolls the dataset from vA.1 to vA.2 and applies a new augmentation profile AP-7. Their pipeline emits a descriptor like “A2C7 . . . ” and recomputes a dataset SimHash. At (2) Alice fine-tunes the model on vA.2 for several days. Each step emits a descriptor; the EMA state updates and the recent tail records the last W descriptors. At (3), a regression appears. Alice compares the latest model checkpoint to the last known good checkpoint from a week ago. She has only two artifacts. Using alpha and the known step gap k, she decay-adjusts the earlier EMA: state_{t1_to_t2}=(1−α)\hat{ }k*stateₜ₁. She compares state_{t1_to_t2} to stateₜ₂. The residual highlights what changed between t1 and t2. She also compares dataset SimHash codes. They are close, so content stayed similar. The EMA residual points to a scheduler and LR bin change in the descriptors. Alice rolls back the offending knobs, validates, and moves on. For audit, the LID capsules ride with the artifacts and tell a compact story of how they were produced.

The proposed concept uses the following infrastructure: (1) A storage for artifacts and their LID capsules. This can be a model registry, an object store, or a file system. (2) A small library to produce and parse LID capsules. No central database is required. (3) Optional services: a verification tool to compare two capsules; a job that computes dataset SimHash per commit; a signing key to sign capsules for integrity.

The method implements a constant-memory streaming update. Parameters M, B, W, and α are chosen once per run or per project. In the first phase, the parameters are chosen. M (EMA bytes) is picked to control capacity. 64 or 128 bytes are typical. B (descriptor bytes) is picked to match how many semantic fields are desired, e.g., 8 or 16. α is picked for the time horizon. To retain about τ after H steps, α≈−ln(τ)/H can be used. For example, to keep 10% after 20,000 steps→α≈1.15e−4. W is picked for recent tail. For example, W=500 (about 4 KB if B=8) may be used.

In a second phase, dispersion mapping is built. In case the dispersion strategy is “stride”: if M is divisible by B, each descriptor byte updates K=M/B positions at offsets i+j*B for j in 0 . . . K−1. This gives full coverage once per step with no collisions. If “seeded permutation” is used, a permutation of 0 . . . M−1 is built using a fixed seed for the run, then K positions per byte are assigned from that permutation. This avoids visible patterns.

In a third phase, per step encoding is performed. This includes obtaining descriptor_current (B bytes), ordinalizing to values 0 . . . 255. For each descriptor byte i, the K assigned EMA indices are updated with the EMA rule. Floats may be kept internally, rounding only for display or hex serialization. descriptor_current is pushed into the recent tail ring buffer (dropping the oldest if size would exceed W). If the dataset content is tracked, the SimHash is computed or updated for the dataset and simhash_current is stored. Then a new LID capsule is produced alongside the artifact.

In a fourth phase, pairwise attribution between snapshots may be performed. Given two capsules at steps t₁ and t₂=t₁+k, the earlier EMA is decayed: E1_{decayed}=(1−α)^{k}*E1. E1_{decayed} is compared to E2 using a distance or cosine similarity. The difference is the net effect of steps t₁+1 . . . t₂. If there is a recent tail and k≤W, exact sequence comparison can be performed for the overlap. For datasets, the SimHash codes may be compared via Hamming distance. Low distance plus high EMA match implies continuity; high EMA match plus high SimHash distance suggests process continuity but data change.

In some cases, merges and ensembles may be handled. If a model at t is formed by merging parents P₁ . . . Pₙ with layer or global weights c₁ . . . cₙ (sum to 1), the merged EMA state may be computed as the same convex combination of their states before continuing updates. Coefficients may be recorded in the capsule for transparency.

To perform serialization, ema_state may be stored as hex (2*M characters). Descriptors in the recent tail may be stored as a dot-joined string or an array. α, B, M, W, dispersion rule or seed, global_step, and optional simhash_current may be included. The blob may be signed if desired.

FIG. 4 shows a sequence diagram for one iteration. At the beginning of the sequence, the parameters are chosen once per run: M, B, W, α, dispersion_rule_or_seed. The orchestrator/trainer uses a descriptor builder to build descriptor_current (B bytes) from the semantic fields. The orchestrator/trainer uses an ordinalizer to ordinalize descriptor bytes to 0 . . . 255, yielding values[0 . . . B−1]. The orchestrator/trainer uses a dispersion map (stride or seeded permutation) to request K indices per byte (to cover M bytes once), yielding index_sets[i] for i in [0 . . . B−1]. In a loop, for each byte in [0 . . . B−1], the orchestrator/trainer updates the indices index_sets[i] with EMA using values[i], using new=(1−α)·old+α·in_byte. The orchestrator/trainer appends descriptor_current to tail (ring buffer size W), obtaining the updated recent_tail (e.g., as joined string or array). The orchestrator/trainer uses a SimHash engine (optional) to compute or update the dataset SimHash (e.g., 64 or 128 bits), yielding simhash_current_hex (and optional tail). The orchestrator/trainer uses a capsule assembler to assemble the capsule fields, and attaches the capsule to the artifact version. For example, the capsule may include one or more of global_step, run_id, timestamp, descriptor_current, recent_tail (last W), ema_state_hex (M bytes), α, M, B, W, dispersion_rule_or_seed, dataset_facet, simhash_current_hex (optional). The artifact and capsule are persisted in a registry artifact store. When a comparison is performed at a later stage, the earlier EMA id decayed with retain=(1−α)^{k}, and E1_{decayed} is compared with E2.

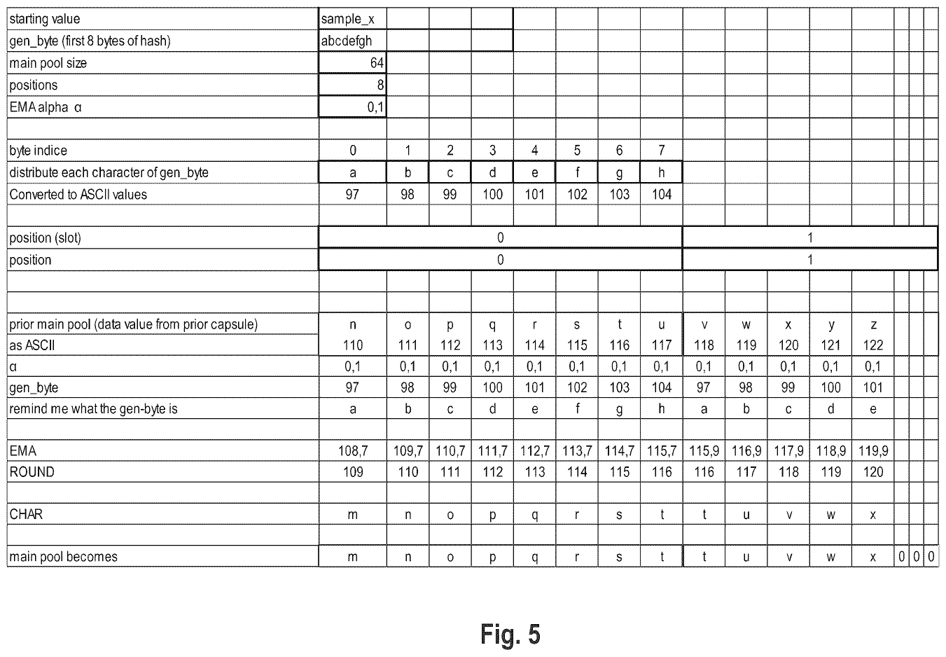

In FIG. 5, a simplified example is shown that is computed within a spreadsheet to demonstrate Exponential Lineage Encoding. Each 8-byte descriptor (“gen-byte”) is mapped across the 64-byte main pool (8 slots×8 columns) and blended by an exponential moving average (alpha=0.10). The result is a constant-size, order-sensitive state in which column i records the decayed influence of byte i over time, enabling direct comparison between checkpoints without retaining intermediate logs.

Each iteration, an 8-byte descriptor is obtained (the “gen-byte”). In the sheet it's shown as: gen_byte=“abcdefgh”, which maps to ASCII values a=97, b=98, . . . , h=104. The main pool is 64 bytes, displayed as eight 8-byte slots. Slot 0 starts as “nopqrstu”, slot 1 starts as “vwxyz . . . ”, slots 2 . . . 7 are present but not shown. As mapping rule (which cells change), the following stride rule is used. For input byte i (0 . . . 7), column i is updated across all eight slots. In linear indices this is i, i+8, i+16, i+24, i+32, i+40, i+48, i+56. In plain terms: byte “a” updates the first character of every slot; byte “b” updates the second character of every slot, and so on. As blending rule (how cells change), an exponential moving average (EMA) is used at each touched position: newᵥₐₗᵤₑ=(1−α)*oldᵥₐₗᵤₑ+α*in_byte. The internal values are kept as floats, rounding to the nearest integer only for display as ASCII or hex. In the sheet, alpha is set to 0.10.

In a first operation, “a” (97) is processed, i=0. The first character (column 0) of every 8-byte slot is updated. In slot 0, the first char was ‘n’ (110). new=0.9110+0.197=108.7→rounds to 109→‘m’. Slot 0 changes from “nopqrstu” to “mopqrstu”. In Slot 1, first char was ‘v’ (118). new=0.9118+0.197=115.9→rounds to 116→‘t’. Slot 1 changes from “vwxyz . . . ” to “twxyz . . . ”. (The same update happens to the first character of Slots 2 . . . 7 in their respective rows.)

In a second operation, “b” (98) is processed, i=1. The second character (column 1) of every slot is updated. In slot 0, the second character was ‘o’ (111). new=0.9111+0.198=109.7→rounds to 110→‘n’. Slot 0 now reads “mnpqrstu”. In slot 1, the second character was ‘w’ (119). new=0.9119+0.198=116.9→rounds to 117→‘u’. Slot 1 now reads “tuxyz . . . ”.

In the third through eighth operation, “c” through “h” are processed. Byte “c” (99) updates the third character (column 2) of all slots. Byte “d” (100) updates the fourth character (column 3), and so on, through “h” (104) updating column 7.

The “prior main pool” row shows the old characters (their ASCII values are what the EMA uses). The “gen-byte” row shows a . . . h (97 . . . 104). The “EMA-updated” row shows the new characters after applying the formula above. Because the sheet rounds for display, some characters may appear unchanged even though the underlying float moved toward the input value. That's expected; rounding is only for readability.

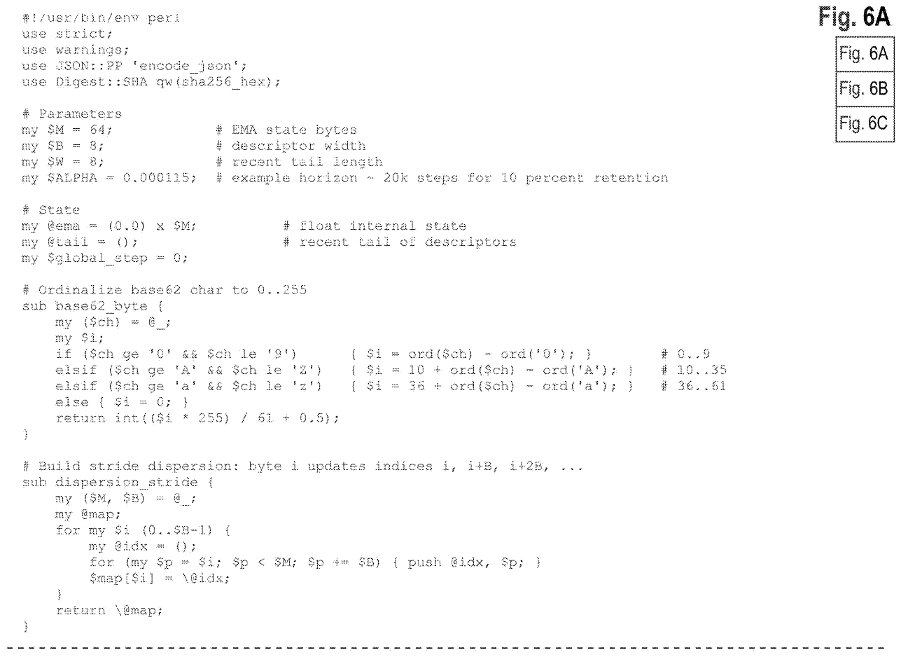

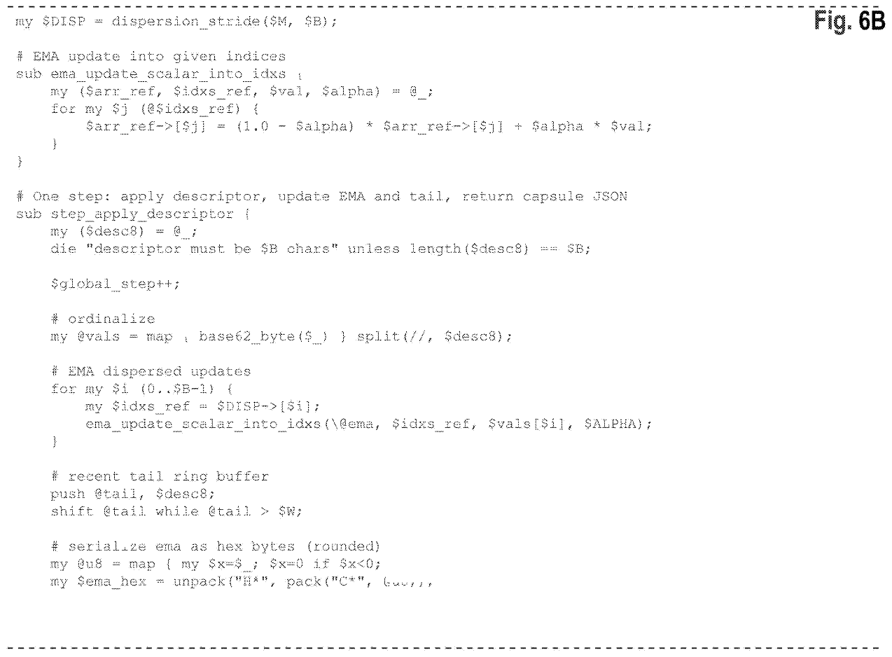

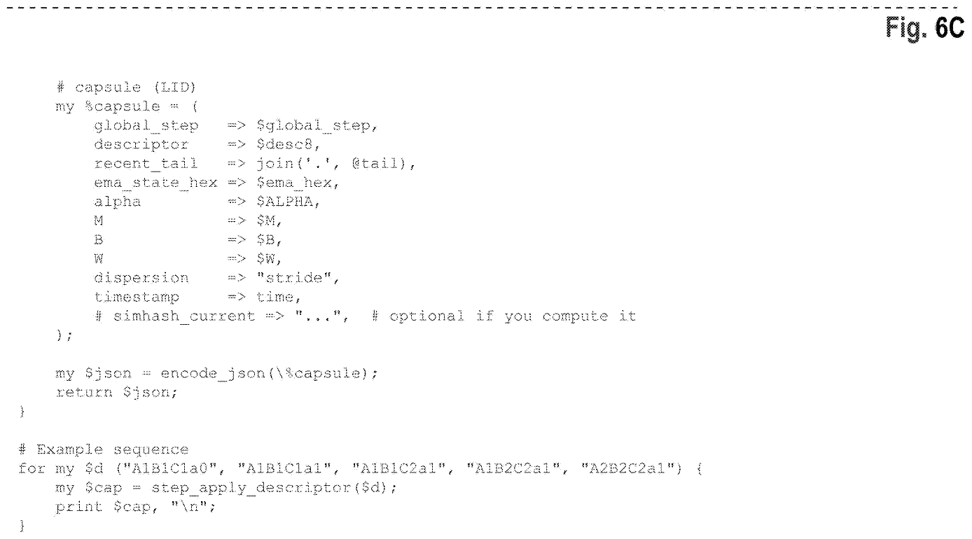

FIG. 6 (broken into partial views 6A, 6B, and 6C) shows a minimal working core of the proposed concept written in the Perl scripting language. This snippet shows descriptor ordinalization (base62_byte), stride dispersion (dispersion_stride), EMA update, recent tail, and capsule assembly.

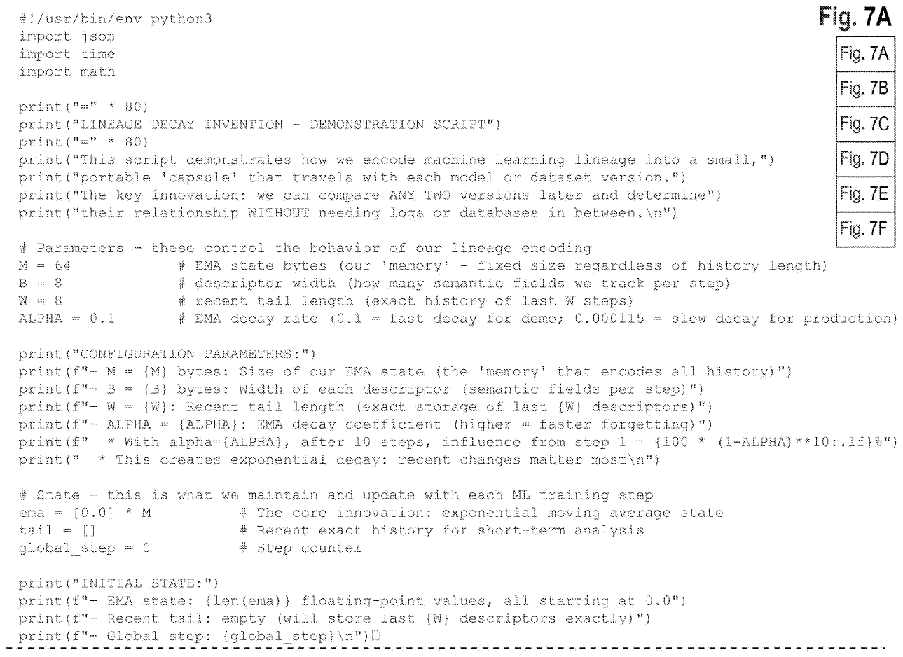

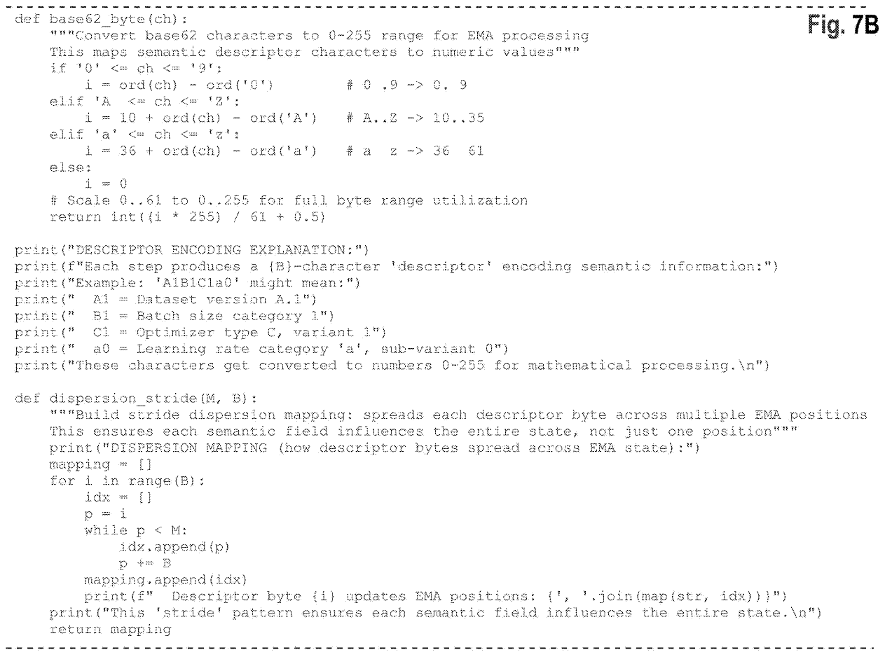

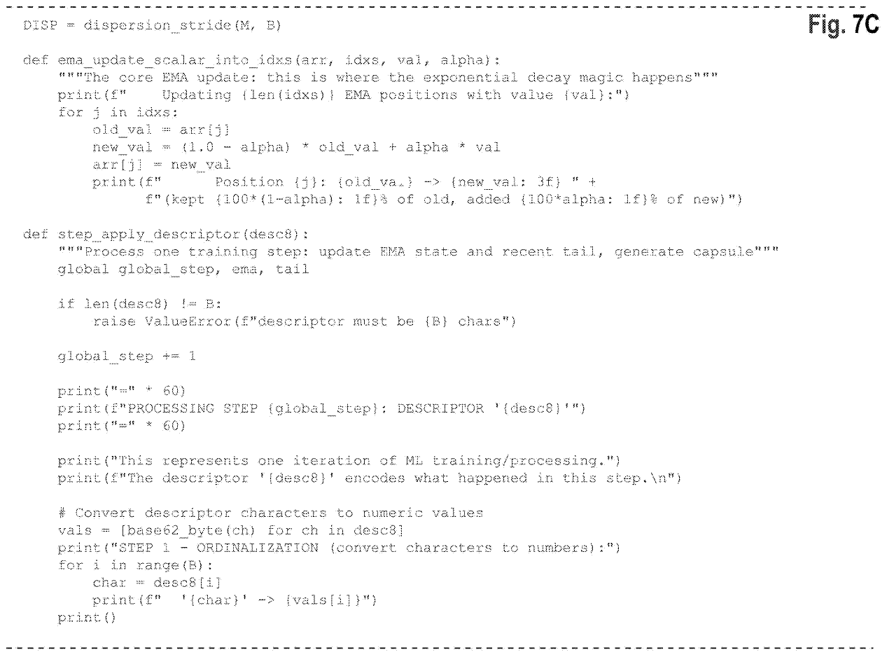

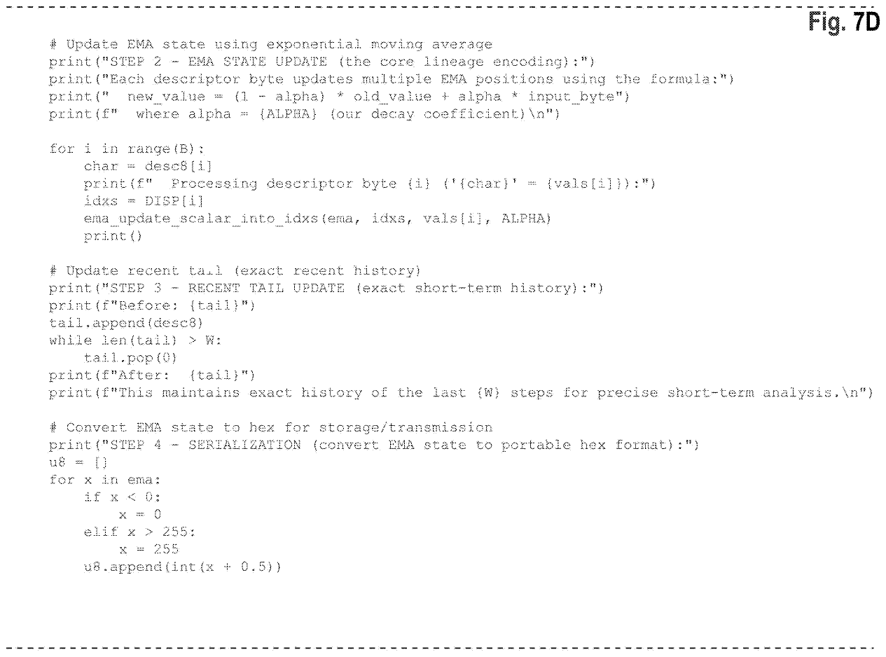

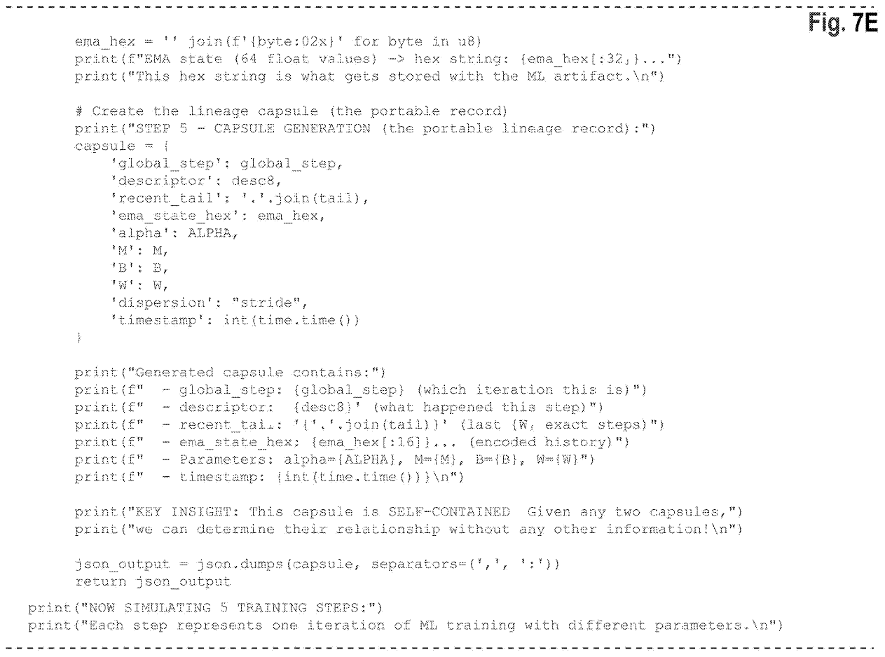

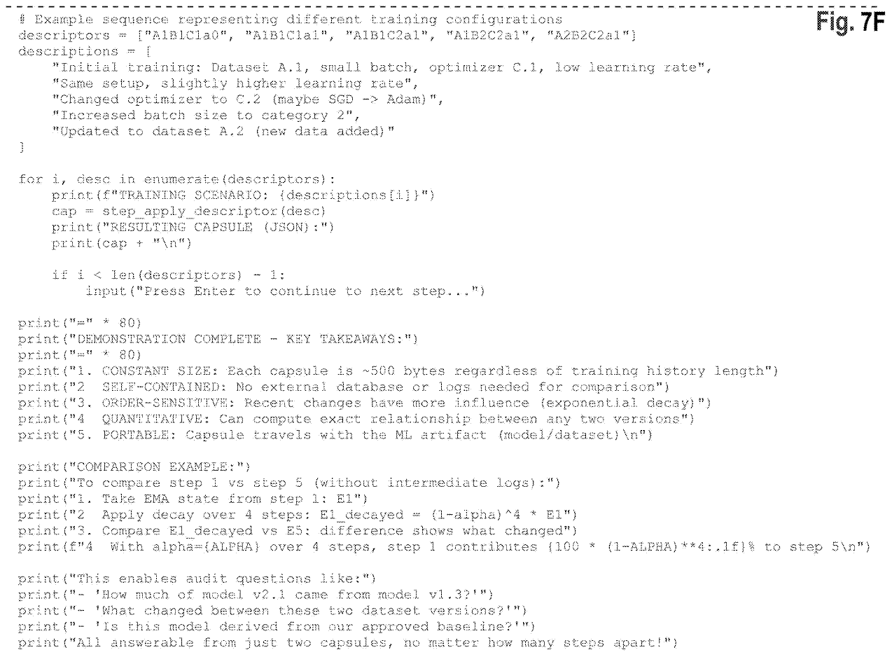

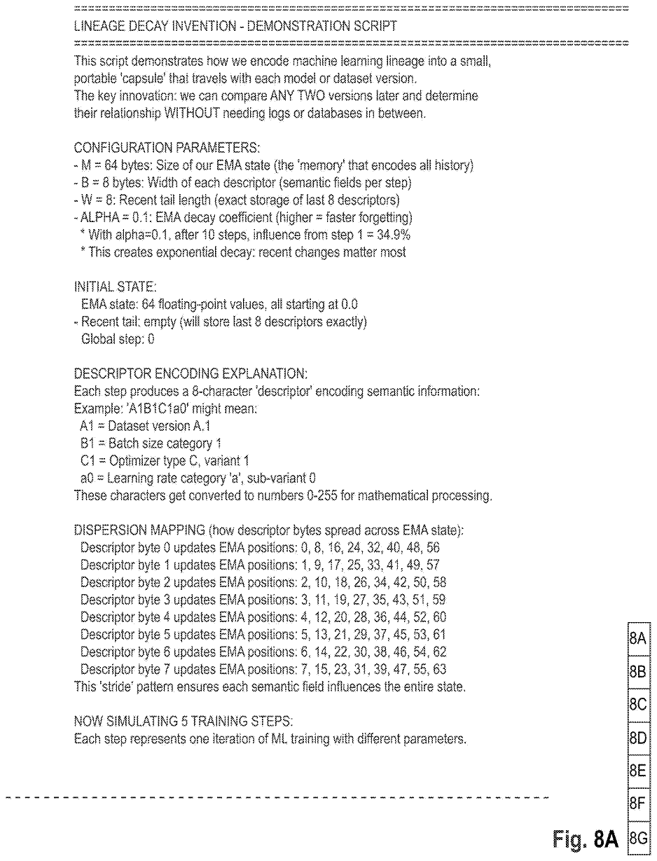

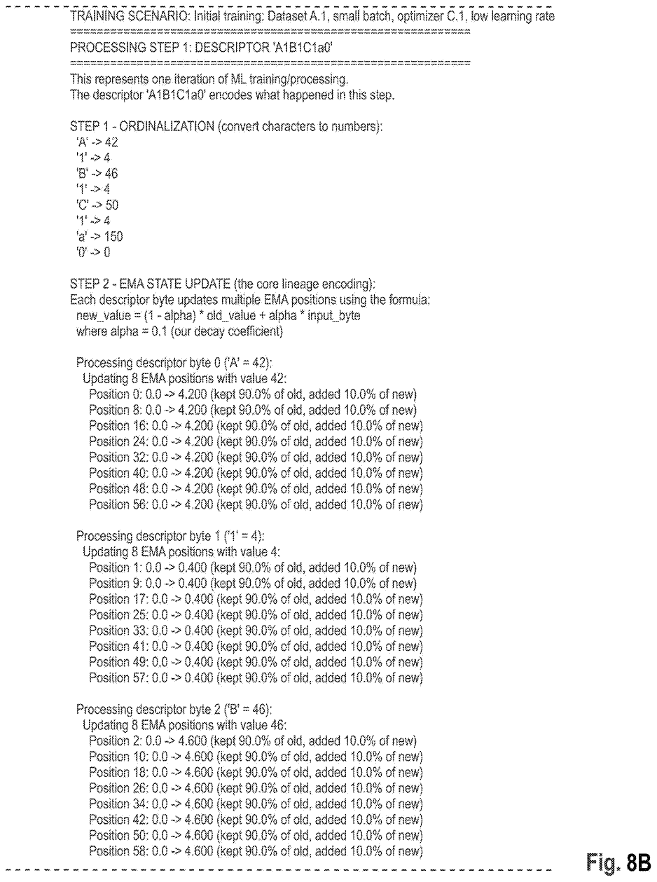

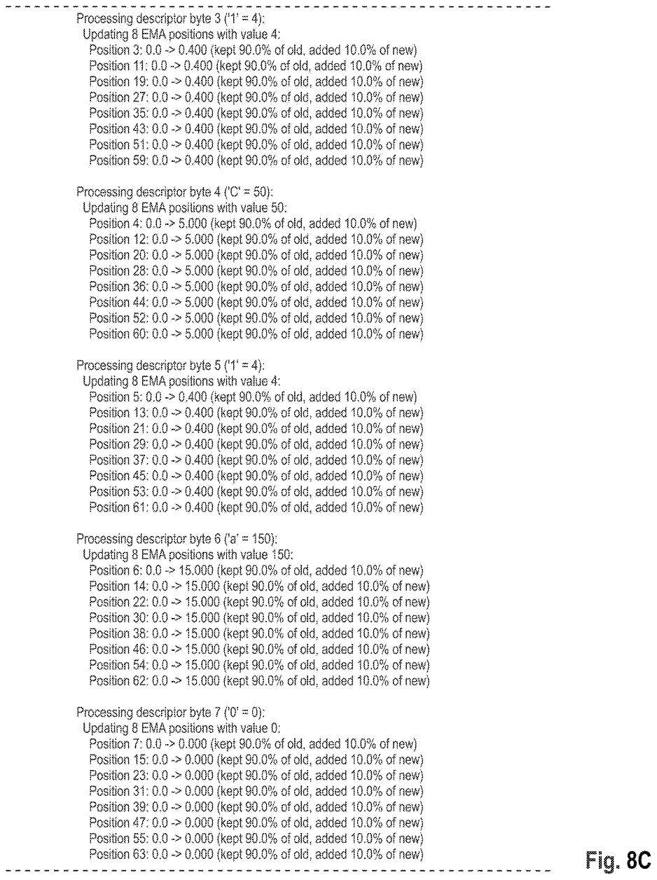

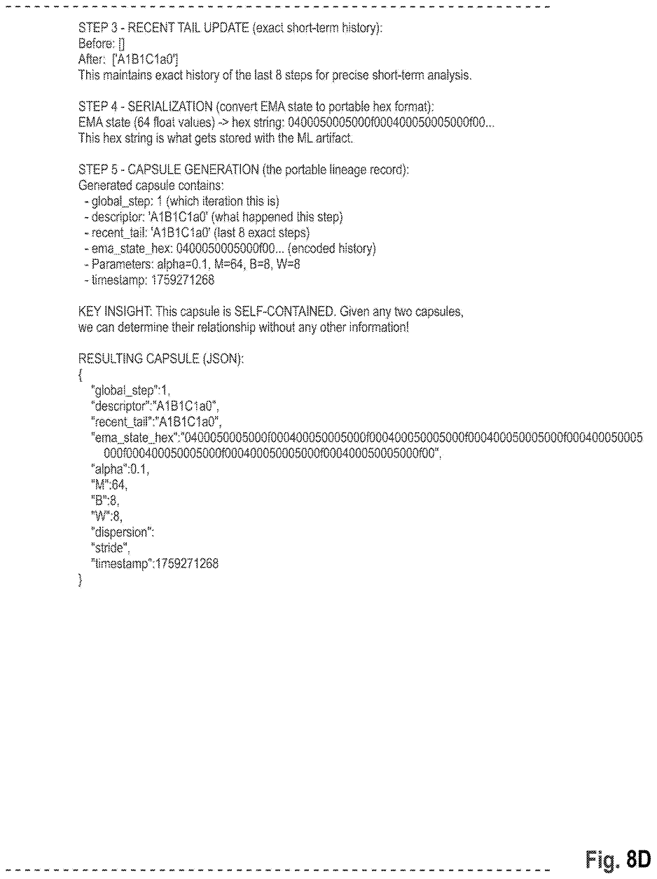

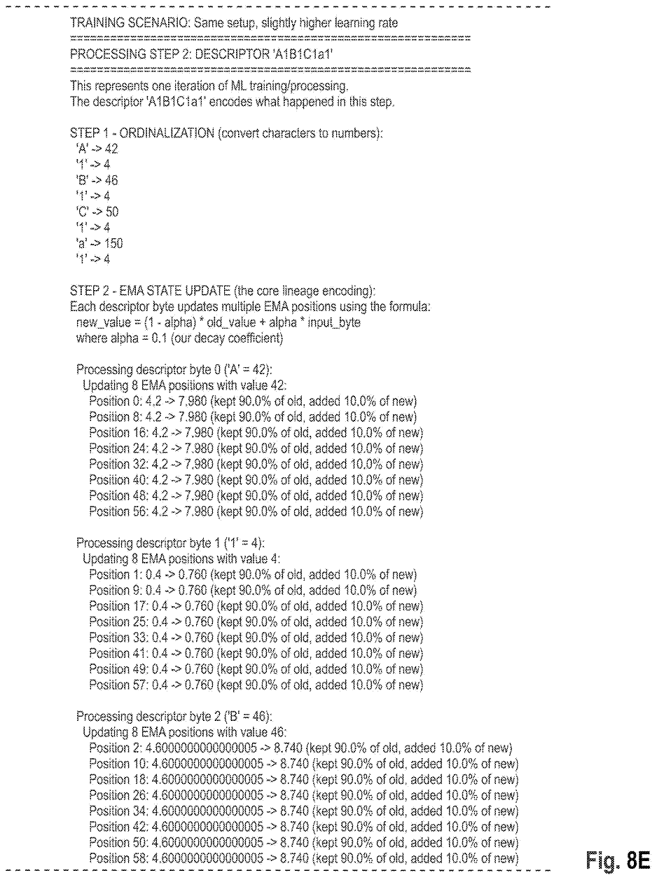

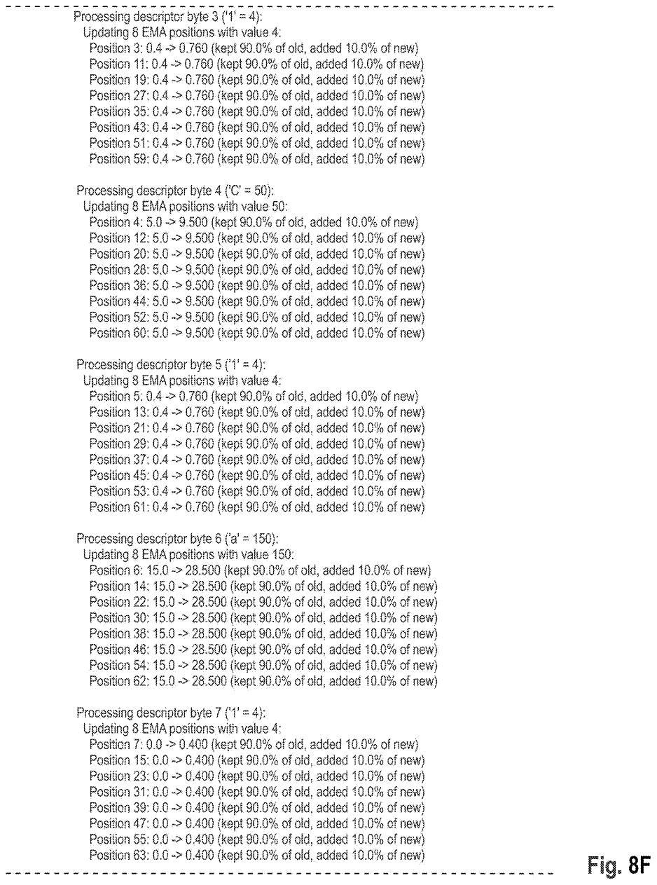

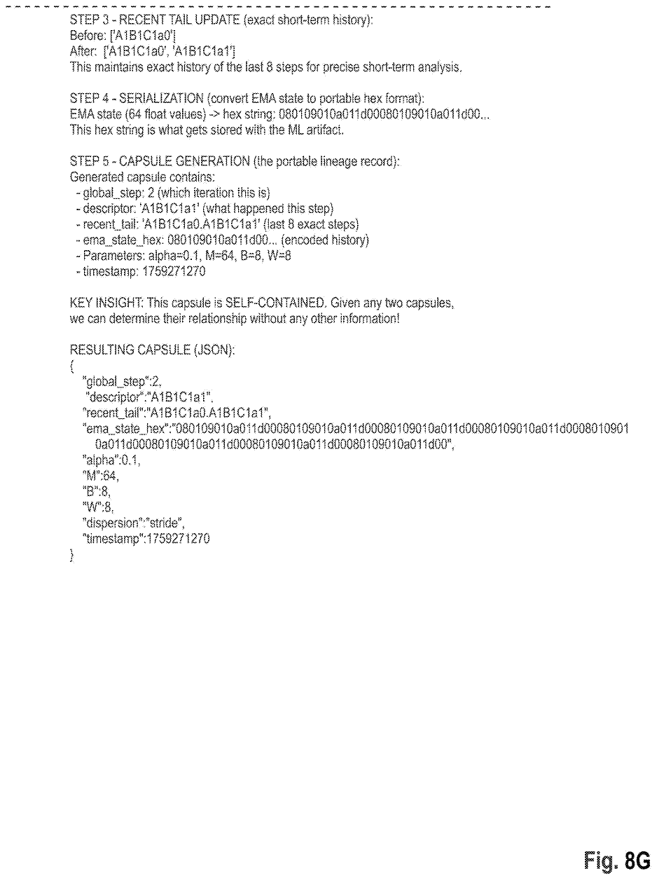

FIG. 7 (broken into partial views 7A to 7F) shows an example implementation of the proposed concept in the Python scripting language. The script starts with setting the parameters and setting up initial variable values. The functions of this script match the functions of the Perl script, with additional comments and print functions to explain the script. FIG. 8 (broken into partial views 8A to 8G) shows an output of the Python script for two processing steps. The JSON output shown in parts 8D and 8G of FIG. 8 is equivalent to the output that would have been provided by the Perl script of FIG. 6.

In the following, a short example of performing a comparison (pairwise attribution) is given. Given two capsules cap₁ and cap₂ at steps t₁ and t₂, α known, the comparison may include the following operations: (1) Parsing ema_state_hex to byte arrays u8₁ and u8₂, then casting to floats. (2) Computing k=t₂−t₁. (3) Computing retain=(1−α)^{k}. (4) E1_{decayed}=retain·E1 (elementwise). (5) Residual=E2−E1_{decayed}. (6) Reporting norms or cosine similarity to quantify relationship.

In the proposed concept, one or more of the following equations are used:

$$EMA update : new = ( 1 - α ) \cdot old + α \cdot in\_byte$$

$$Retention over k steps : retain = {( 1 - α )}^{k} \approx exp ( - α \cdot k )$$

$$Decay of earlier state : E1\_to \_E2 = retain \cdot E 1$$

$$Residual of intervening steps : R = E 2 - E1\_to \_E2$$

The proposed mechanism does not compress model weights or raw data. It encodes the change process itself as a tiny, analyzable state. The explicit recent tail makes short-term behavior easy to read. The EMA state provides long-horizon correlation. Together they allow snapshot-to-snapshot attribution without intermediate logs.

In some examples, a SimHash is included in the capsule. In the proposed concept, a capsule is the small record that is attached to each artifact version. It travels with the artifact. It contains the fields needed to compare two snapshots later without pulling a database of logs. The benefit of using the gen-byte is that it can track progressive lineage that is “non-syntactic”. The benefit of using a SimHash is that it can track progressive lineage that is heavily syntactic. Adding the SimHash functionality therefore makes sense to further improve our lineage tracking. SimHash complements the EMA lineage state. The EMA over descriptors captures process and order (non-syntactic lineage). SimHash captures dataset content similarity (syntactic lineage). The SimHash may be stored side-by-side with the EMA state, not mixed into it.

A dataset SimHash may be computed per dataset snapshot or per dataset delta. The specific feature map and hyperplanes are implementation choices for the data team. The proposed concept does not depend on one exact SimHash variant. Because SimHash is well known, detailed code is not included here.

In the capsule, the following pieces of information may be stored: simhash_bits (e.g., 64 or 128), simhash_current_hex (the current SimHash as hex). Optionally, for richer debugging or incremental updates, the following pieces of information may additionally be stored: simhash_tail_hex (array of the last K SimHashes as hex (for example K=8)), simhash_method (a short string, for example “SimHash v1”), simhash_seed (seed for the random hyperplanes if you want deterministic recomputation), simhash_accumulator (optional compact form of the running vector that produced the SimHash (e.g., 128 signed integers), allowing fast adding/removing deltas without rescanning raw data).

When comparing two capsules, the EMA state is used to determine process similarity with decay. retain=(1−α)^{k} is computed, the earlier EMA is decayed and compared to the later EMA. The SimHash is used to determine content similarity. For example, the normalized Hamming distance between simhash_current_hex values may be computed. The EMA state and the SimHash may be interpreted together. High EMA similarity and low SimHash distance imply strong continuity. High EMA similarity and high SimHash distance implies process continuity but changes in data. Low EMA similarity and low SimHash distance imply same data but a different process path.

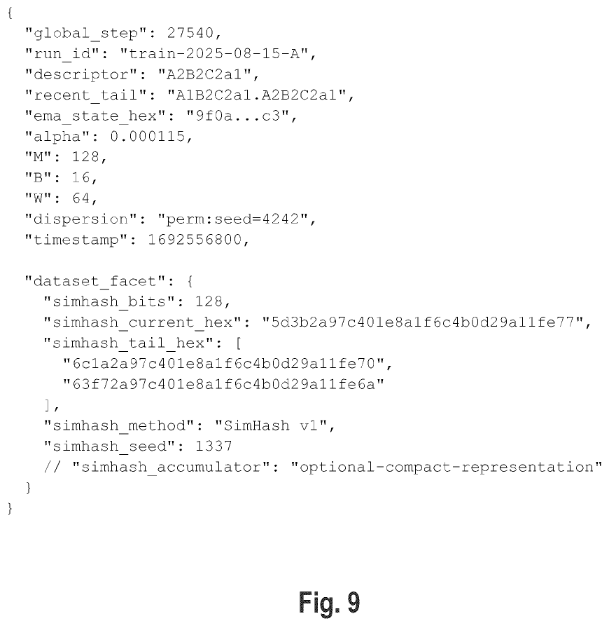

FIG. 9 shows a JSON representation of an example capsule with SimHash fields. This is an example—the field names are merely examples.

Various examples of the proposed concept use exponential decay in streaming lineage encoding. For example, each step may be encoded as an 8-byte descriptor (“gen-byte”). Each step may update a fixed-size state (main pool and, optionally, a marker pool) using an exponential moving average (EMA). EMA gives higher weight to recent steps while retaining all prior history with exponentially decreasing weights. The result is a constant-memory, order-sensitive lineage code you can carry with a model or dataset.

The EMA update rule (per index) may be xₜ=(1−α)·x_{{t-1}}+α·uₜ is the incoming byte (0-255). The state may be kept as floats internally, rounding only for display (ASCII or hex).

The following retention over time may be provided. A contribution from k steps ago is multiplied by (1−α)^{k}. For small alpha, (1−α)^{k}≈exp(−α·k). Half-life (in steps)≈0.693/α. Effective window width≈1/α. Pool size affects capacity/detail, while decay speed is controlled by alpha. If the goal is to retain approximately τ (e.g., 10%=0.10) after H steps, α≈−ln(τ)/H. For example, to keep ~10% after 200 steps→α≈0.0115. To keep ~10% after 20,000 steps, α≈0.000115. For a half-life of 1,000 steps→α≈0.000693.

Dispersing each input byte across several indices (stride or seeded permutation) spreads influence spatially, but does not change temporal decay. Every touched index still decays by the same (1−α) factor per update.

To relate two snapshots without logs, given snapshots at t₁ and t₂=t₁+k and a known α: To determine a predicted portion of the later state that comes from the earlier snapshot: x_from_t1=(1−α)^{k}·xₜ₁. To determine a residual from the intervening steps: residual=xₜ₂−x_from_t1. This may be computed per index and summarized with a norm or cosine similarity to quantify relationship strength.

In some examples, a multi-band design may be used (optional). For example, two or three pools with different alphas may be used to target different horizons: For example, a fast band (recent): α~0.05−0.15, a mid-band (hundreds of steps): α~0.005−0.02 and an ultra-slow band (thousands to tens of thousands): α~1e−4 may be used.

In some examples, step awareness may be supported (optional). This may be achieved by keeping an out-of-band counter (global_step) in the metadata. Optionally, a “metronome” byte may be added that is updated toward a constant via EMA so the step count can be estimated from the state alone.

The proposed concept provides a mechanism denoted as Exponential Lineage Encoding: a fixed-size, streaming state updated by EMA at each step, enabling quantitative ancestry and attribution between checkpoints without retaining intermediate logs.

The proposed concept is not equal to a sliding window. A sliding window throws away history outside the last W steps. Here, exponential decay is used: every past step remains in the state but is down-weighted by (1−α)\hat{ }k after k iterations. α can be chosen to match the time horizon of interest (smaller α=longer memory).

The proposed concept operates on the semantic content/metadata of the data, not the raw binary file itself. The proposed concept does not perform binary file hashing, e.g., model.pkl→SHA256→fixed hash, dataset.csv→MD5→fixed hash, which is brittle to trivial changes and includes no lineage information. The proposed concept uses content-aware lineage encoding. For example, in case of an Excel/SQLite/CSV file, the semantic descriptors are extracted and turned into an EMA encoding. For example, for a Dataset (Excel/CSV/SQLite): (1) Row count bin: 1M-10M rows→‘C’, (2) Schema version: v2.1→‘B’, (3) Data quality score: 95% clean→‘9’, (4) Source system: CRM→‘R’. For a Model: (1) Architecture: ResNet50→‘R’, (2) Training epochs: 100-200→‘H’, (3) Validation accuracy bin: 90-95%→‘A’, (4) Optimizer: Adam→‘M’.

The proposed concept encodes what the data represents and how it was processed, not just its binary fingerprint. This allows tracking properties such as the following: “Dataset grew from 1M to 5M rows” (semantic change), “Model accuracy improved from 85% to 92%” (performance evolution), “Switched from SGD to Adam optimizer” (process change). Even if the underlying files are completely different binaries, the semantic relationship between versions can be quantified. This is why the proposed concept is denoted “lineage decay”—the evolution of meaning and process is tracked, not just file integrity.

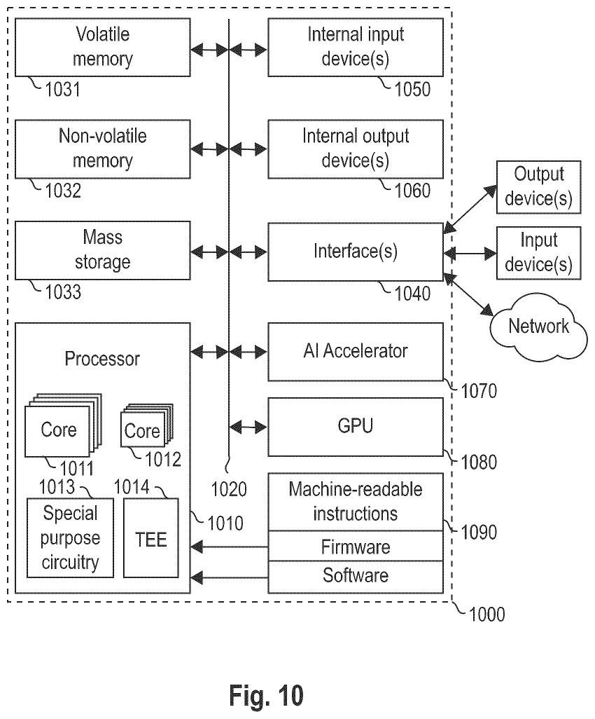

FIG. 10 shows a block diagram of an example computer system 1000 or computing device 1000 structured to execute and/or instantiate the machine-readable instructions and/or operations of FIGS. 1a to 9 to implement the method, apparatuses 10, 20, or devices 10, 20 for the computer system 100. The computer system 1000 or computing device 1000 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 1000 or computing device 1000 of the illustrated example includes processor circuitry 1010. The processor circuitry 1010 of the illustrated example is hardware. For example, the processor circuitry 1010 can be implemented by one or more integrated circuits, logic circuits, FPGAs (Field-Programmable Gate Arrays), microprocessors, CPUs (Central Processing Units), GPUs (Graphics Processing Units), DSPs (Digital Signal Processors), and/or microcontrollers from any desired family or manufacturer. The processor circuitry 1010 may be implemented by one or more semiconductor-based (e.g., silicon-based) devices. For example, the processor circuitry 1010 may provide the functionality of the computer system 1000 or computing device 1000.

The processor circuitry 1010 comprises one or more processor cores 1011 and 1012. For example, the processor circuitry 1010 may have heterogeneous cores. Heterogeneous cores in CPUs refer to the use of different types of cores within a single processor, typically combining high-performance (BIG) cores with power-efficient (LITTLE) cores. Thus, the processor circuitry 1010 may comprise one or more BIG cores 1011 and one or more LITTLE cores 1012. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 1010 of the illustrated example is in communication with a main memory via one or more bus interfaces 1020, including a volatile memory 1031 and a non-volatile memory 1032. The volatile memory 1031 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1032 may be implemented by flash memory and/or any other desired type of memory device. Access to the main memory 1031, 1032 of the illustrated example is controlled by a memory controller, which may be implemented by special-purpose circuitry 1013 of the processor circuitry 1010.

The computer system 1000 or computing device 1000 of the illustrated example also includes one or more mass storage devices 1033 to store software and/or data. Examples of such mass storage devices 1033 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 1000 or computing device 1000 of the illustrated example also includes interface circuitry 1040. The interface circuitry 1040 may be implemented by hardware in accordance with any type of interface standard, such as an Ethernet interface, a WiFi interface, a cellular modem, a universal serial bus (USB) interface, a Bluetooth® interface, a near-field communication (NFC) interface, a PCI (Peripheral Component Interconnect) interface, and/or a PCle (Peripheral Component Interconnect Express) interface. For example, the interface circuitry 1040 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be, for example, an Ethernet connection, a digital subscriber line (DSL) connection, a telephone line connection, a coaxial cable system, a satellite system, a line-of-sight wireless system, a cellular telephone system, an optical connection, etc.

In the illustrated example, one or more internal input devices 1050 and/or one or more external input devices are connected to the interface circuitry 1040 or the bus 1020. The input device(s) permit a user to enter data and/or commands into the processor circuitry 1010. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 1060 and/or one or more external output devices are also connected to the interface circuitry 1040 of the illustrated example. The output devices 1060 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or a speaker. The computer system 1000 or computing device 1000 of the illustrated example, thus, typically includes a graphics driver card, a graphics driver chip, and/or graphics processor circuitry such as a GPU 1013, 1080, which may correspond to or be part of the processor circuitry 1010, for example as special purpose circuitry 1013 or as cores 1011, 1012, or separate from the processor 1010, for example as a separate GPU 1080.

The computer system 1000 or computing device 1000 of the illustrated example may include an AI Accelerator 1070. For example, the AI Accelerator 1070 may be configured to improve the computational speed and efficiency of machine learning tasks by executing parallel processing operations tailored for neural network models. The AI Accelerator 1070 may include hardware such as Graphics Processing Units (GPUs), Tensor Processing Units (TPUs), or other specialized processors designed to handle large volumes of data with low latency. For example, the Processor 1010, the AI Accelerator 1070, the integrated GPU 1013, and/or the dedicated GPU 1080 may be considered xPUs (x Processing Units, where x is a placeholder) of the computer system 700 or computing device 700.

The computer system 1000 or computing device 1000 of the illustrated example includes machine-readable instructions 1090. For example, the machine-readable instructions may be part of firmware or software of the computer system 1000 or computing device 1000. The machine-readable instructions 1090 may be stored in the mass storage device 1033, in the volatile memory 1031, in the non-volatile memory 1032, and/or on a removable non-transitory computer-readable storage medium such as a CD or DVD.

In the following, some examples of the proposed concept are presented:

An example (e.g., example 1) relates to a non-transitory computer-readable medium storing instructions that, when executed by one or more processing circuitries, cause the one or more processing circuitries to perform a method for a computer system, the method comprising obtaining a set of data, determining at least one semantic descriptor characterizing a current state of the set of data, determining whether the set of data is associated with a data structure comprising at least one semantic descriptor characterizing a previous state of the set of data, in response to a negative determination, creating a new data structure comprising the determined at least one semantic descriptor characterizing the current state of the set of data, in response to a positive determination, computing a combination of (i) a decayed version of the at least one semantic descriptor characterizing the previous state of the set of data and (ii) the at least one semantic descriptor characterizing the current state of the set of data, and updating the data structure based on the combination.

Another example (e.g., example 2) relates to a previous example (e.g., example 1) or to any other example, further comprising that the at least one descriptor comprises a composite descriptor that is based on a plurality of semantic descriptors that respectively characterize a plurality of aspects of the state of the set of data.

Another example (e.g., example 3) relates to a previous example (e.g., example 2) or to any other example, further comprising that the composite descriptor is determined such that the impact of the individual semantic descriptors of the plurality of semantic descriptors is dispersed across the composite descriptor.

Another example (e.g., example 4) relates to a previous example (e.g., one of the examples 1 to 3) or to any other example, further comprising that the at least one semantic descriptor comprises a plurality of sets of bits, with each set of bits representing a number, wherein the decayed version is computed by applying a mathematical function to the number represented by the respective set of bits.

Another example (e.g., example 5) relates to a previous example (e.g., one of the examples 1 to 4) or to any other example, further comprising that the decayed version is based on an exponentially decaying version of semantic descriptors representing a plurality of previous states.

Another example (e.g., example 6) relates to a previous example (e.g., one of the examples 1 to 5) or to any other example, further comprising that the data structure comprises up to a predefined number of sets of semantic descriptors representing up to the predefined number of previous states of the set of data.

Another example (e.g., example 7) relates to a previous example (e.g., one of the examples 1 to 6) or to any other example, further comprising that the at least one semantic descriptor is based on metadata characterizing the set of data.

Another example (e.g., example 8) relates to a previous example (e.g., one of the examples 1 to 7) or to any other example, further comprising that the set of data relates to machine learning, wherein the at least one semantic descriptor represents at least one of a dataset version, a dataset size, a machine learning stack version, an augmentation profile, an optimizer used, or a learning rate.

Another example (e.g., example 9) relates to a previous example (e.g., one of the examples 1 to 8) or to any other example, further comprising that the method further comprises determining (125) a content fingerprint of the current state of the set of data, and including the content fingerprint in the data structure.

Another example (e.g., example 10) relates to a previous example (e.g., example 9) or to any other example, further comprising that the content fingerprint is based on the SimHash algorithm.

Another example (e.g., example 11) relates to a previous example (e.g., one of the examples 1 to 10) or to any other example, further comprising that if the set of data is created by combining at least two sets of data that are associated with respective data structures, the method comprises combining (140) the at least one semantic descriptor of the respective data structures to determine the at least one semantic descriptor for the set of data.

Another example (e.g., example 12) relates to a previous example (e.g., one of the examples 1 to 11) or to any other example, further comprising that the data structure has a fixed maximal size and a fixed number of semantic descriptors per state.

Another example (e.g., example 13) relates to a previous example (e.g., one of the examples 1 to 12) or to any other example, further comprising that the decayed version is calculated using a decay parameter.

Another example (e.g., example 14) relates to a previous example (e.g., example 13) or to any other example, further comprising that the decayed version of a semantic descriptor is calculated using (1−alpha)^{k}*Eₚᵣₑᵥᵢₒᵤₛ, where alpha is the decay parameter, k is the number of updates since the previous state, and Eₚᵣₑᵥᵢₒᵤₛ is the semantic descriptor included in the data structure for the previous state.

An example (e.g., example 15) relates to a non-transitory computer-readable medium storing instructions that, when executed by one or more processing circuitries, cause the one or more processing circuitries to perform a method for a computer system, the method comprising obtaining (210) a first data structure comprising at least one semantic descriptor characterizing a first state of a set of data, obtaining (220) a second data structure comprising at least one semantic descriptor characterizing a second state of the set of data, wherein the at least one semantic descriptor characterizing the second state of the set of data is based on a decayed version of the at least one semantic descriptor characterizing the first state of the set of data, and determining (230) a lineage between the first state and the second state of the set of data based on the at least one semantic descriptor.

Another example (e.g., example 16) relates to a previous example (e.g., one of the examples 1 to 15) or to any other example, further comprising that the respective data structures are determined or updated using the method of at least one of the examples 1 to 15.

An example (e.g., example 17) relates to a method for a computer system, the method comprising obtaining (110) a set of data, determining (120) at least one semantic descriptor characterizing a current state of the set of data, determining (130) whether the set of data is associated with a data structure comprising at least one semantic descriptor characterizing a previous state of the set of data, in response to a negative determination, creating (150) a new data structure comprising the determined at least one semantic descriptor characterizing the current state of the set of data, in response to a positive determination, computing (160) a combination of (i) a decayed version of the at least one semantic descriptor characterizing the previous state of the set of data and (ii) the at least one semantic descriptor characterizing the current state of the set of data, and updating (165) the data structure based on the combination.

Another example (e.g., example 18) relates to a previous example (e.g., example 17) or to any other example, further comprising that the at least one descriptor comprises a composite descriptor that is based on a plurality of semantic descriptors that respectively characterize a plurality of aspects of the state of the set of data.

Another example (e.g., example 19) relates to a previous example (e.g., example 18) or to any other example, further comprising that the composite descriptor is determined such that the impact of the individual semantic descriptors of the plurality of semantic descriptors is dispersed across the composite descriptor.

Another example (e.g., example 20) relates to a previous example (e.g., one of the examples 17 to 19) or to any other example, further comprising that the at least one semantic descriptor comprises a plurality of sets of bits, with each set of bits representing a number, wherein the decayed version is computed by applying a mathematical function to the number represented by the respective set of bits.

Another example (e.g., example 21) relates to a previous example (e.g., one of the examples 17 to 20) or to any other example, further comprising that the decayed version is based on an exponentially decaying version of semantic descriptors representing a plurality of previous states.

Another example (e.g., example 22) relates to a previous example (e.g., one of the examples 17 to 21) or to any other example, further comprising that the data structure comprises up to a predefined number of sets of semantic descriptors representing up to the predefined number of previous states of the set of data.

Another example (e.g., example 23) relates to a previous example (e.g., one of the examples 17 to 22) or to any other example, further comprising that the at least one semantic descriptor is based on metadata characterizing the set of data.

Another example (e.g., example 24) relates to a previous example (e.g., one of the examples 17 to 23) or to any other example, further comprising that the set of data relates to machine learning, wherein the at least one semantic descriptor represents at least one of a dataset version, a dataset size, a machine learning stack version, an augmentation profile, an optimizer used, or learning rate.

Another example (e.g., example 25) relates to a previous example (e.g., one of the examples 17 to 24) or to any other example, further comprising that the method further comprises determining (125) a content fingerprint of the current state of the set of data, and including the content fingerprint in the data structure.

Another example (e.g., example 26) relates to a previous example (e.g., example 25) or to any other example, further comprising that the content fingerprint is based on the SimHash algorithm.

Another example (e.g., example 27) relates to a previous example (e.g., one of the examples 17 to 26) or to any other example, further comprising that if the set of data is created by combining at least two sets of data that are associated with respective data structures, the method comprises combining (140) the at least one semantic descriptor of the respective data structures to determine the at least one semantic descriptor for the set of data.

Another example (e.g., example 28) relates to a previous example (e.g., one of the examples 17 to 27) or to any other example, further comprising that the data structure has a fixed maximal size and a fixed number of semantic descriptors per state.

Another example (e.g., example 29) relates to a previous example (e.g., one of the examples 17 to 28) or to any other example, further comprising that the decayed version is calculated using a decay parameter.

Another example (e.g., example 30) relates to a previous example (e.g., example 29) or to any other example, further comprising that the decayed version of a semantic descriptor is calculated using (1−alpha)^{k}*Eₚᵣₑᵥᵢₒᵤₛ, where alpha is the decay parameter, k is the number of updates since the previous state, and Eₚᵣₑᵥᵢₒᵤₛ is the semantic descriptor included in the data structure for the previous state.

An example (e.g., example 31) relates to a method for a computer system, the method comprising obtaining (210) a first data structure comprising at least one semantic descriptor characterizing a first state of a set of data, obtaining (220) a second data structure comprising at least one semantic descriptor characterizing a second state of the set of data, wherein the at least one semantic descriptor characterizing the second state of the set of data is based on a decayed version of the at least one semantic descriptor characterizing the first state of the set of data, and determining (230) a lineage between the first state and the second state of the set of data based on the at least one semantic descriptor.

Another example (e.g., example 32) relates to a previous example (e.g., one of the examples 17 to 31) or to any other example, further comprising that the respective data structures are determined or updated using the method of at least one of the examples 17 to 31.

An example (e.g., example 33) relates to an apparatus (10) for a computer system (100), the apparatus (10) comprising memory or storage circuitry (16), machine-readable instructions, and processor circuitry (14) to execute the machine-readable instructions to obtain a set of data, determine at least one semantic descriptor characterizing a current state of the set of data, determine whether the set of data is associated with a data structure comprising at least one semantic descriptor characterizing a previous state of the set of data, in response to a negative determination, create a new data structure comprising the determined at least one semantic descriptor characterizing the current state of the set of data, in response to a positive determination, compute a combination of (i) a decayed version of the at least one semantic descriptor characterizing the previous state of the set of data and (ii) the at least one semantic descriptor characterizing the current state of the set of data, and update the data structure based on the combination.

Another example (e.g., example 34) relates to a previous example (e.g., example 33) or to any other example, further comprising that the at least one descriptor comprises a composite descriptor that is based on a plurality of semantic descriptors that respectively characterize a plurality of aspects of the state of the set of data.

Another example (e.g., example 35) relates to a previous example (e.g., example 34) or to any other example, further comprising that the composite descriptor is determined such that the impact of the individual semantic descriptors of the plurality of semantic descriptors is dispersed across the composite descriptor.

Another example (e.g., example 36) relates to a previous example (e.g., one of the examples 33 to 35) or to any other example, further comprising that the at least one semantic descriptor comprises a plurality of sets of bits, with each set of bits representing a number, wherein the decayed version is computed by applying a mathematical function to the number represented by the respective set of bits.

Another example (e.g., example 37) relates to a previous example (e.g., one of the examples 33 to 36) or to any other example, further comprising that the decayed version is based on an exponentially decaying version of semantic descriptors representing a plurality of previous states.

Another example (e.g., example 38) relates to a previous example (e.g., one of the examples 33 to 37) or to any other example, further comprising that the data structure comprises up to a predefined number of sets of semantic descriptors representing up to the predefined number of previous states of the set of data.

Another example (e.g., example 39) relates to a previous example (e.g., one of the examples 33 to 38) or to any other example, further comprising that the at least one semantic descriptor is based on metadata characterizing the set of data.

Another example (e.g., example 40) relates to a previous example (e.g., one of the examples 33 to 39) or to any other example, further comprising that the set of data relates to machine learning, wherein the at least one semantic descriptor represents at least one of a dataset version, a dataset size, a machine learning stack version, an augmentation profile, an optimizer used, or learning rate.

Another example (e.g., example 41) relates to a previous example (e.g., one of the examples 33 to 40) or to any other example, further comprising that the processor circuitry is to execute the machine-readable instructions to determine a content fingerprint of the current state of the set of data, and including the content fingerprint in the data structure.

Another example (e.g., example 42) relates to a previous example (e.g., example 41) or to any other example, further comprising that the content fingerprint is based on the SimHash algorithm.

Another example (e.g., example 43) relates to a previous example (e.g., one of the examples 33 to 42) or to any other example, further comprising that if the set of data is created by combining at least two sets of data that are associated with respective data structures, the processor circuitry is to execute the machine-readable instructions to combine the at least one semantic descriptor of the respective data structures to determine the at least one semantic descriptor for the set of data.

Another example (e.g., example 44) relates to a previous example (e.g., one of the examples 33 to 43) or to any other example, further comprising that the data structure has a fixed maximal size and a fixed number of semantic descriptors per state.

Another example (e.g., example 45) relates to a previous example (e.g., one of the examples 33 to 44) or to any other example, further comprising that the decayed version is calculated using a decay parameter.

Another example (e.g., example 46) relates to a previous example (e.g., example 45) or to any other example, further comprising that the decayed version of a semantic descriptor is calculated using (1−alpha)^{k}*Eₚᵣₑᵥᵢₒᵤₛ, where alpha is the decay parameter, k is the number of updates since the previous state, and Eₚᵣₑᵥᵢₒᵤₛ is the semantic descriptor included in the data structure for the previous state.

An example (e.g., example 47) relates to an apparatus (20) for a computer system (100), the apparatus (20) comprising memory or storage circuitry (26), machine-readable instructions, and processor circuitry (24) to execute the machine-readable instructions to obtain a first data structure comprising at least one semantic descriptor characterizing a first state of a set of data, obtain a second data structure comprising at least one semantic descriptor characterizing a second state of the set of data, wherein the at least one semantic descriptor characterizing the second state of the set of data is based on a decayed version of the at least one semantic descriptor characterizing the first state of the set of data, and determine a lineage between the first state and the second state of the set of data based on the at least one semantic descriptor.

Another example (e.g., example 48) relates to a previous example (e.g., one of the examples 33 to 47) or to any other example, further comprising that the respective data structures are determined or updated using the apparatus of at least one of the examples 33 to 47.

An example (e.g., example 49) relates to a device (10) for a computer system (100), the device (10) comprising memory (16), machine-readable instructions, and means for processing (14) to obtain a set of data, determine at least one semantic descriptor characterizing a current state of the set of data, determine whether the set of data is associated with a data structure comprising at least one semantic descriptor characterizing a previous state of the set of data, in response to a negative determination, create a new data structure comprising the determined at least one semantic descriptor characterizing the current state of the set of data, in response to a positive determination, compute a combination of (i) a decayed version of the at least one semantic descriptor characterizing the previous state of the set of data and (ii) the at least one semantic descriptor characterizing the current state of the set of data, and update the data structure based on the combination.

Another example (e.g., example 50) relates to a previous example (e.g., example 49) or to any other example, further comprising that the at least one descriptor comprises a composite descriptor that is based on a plurality of semantic descriptors that respectively characterize a plurality of aspects of the state of the set of data.

Another example (e.g., example 51) relates to a previous example (e.g., example 50) or to any other example, further comprising that the composite descriptor is determined such that the impact of the individual semantic descriptors of the plurality of semantic descriptors is dispersed across the composite descriptor.

Another example (e.g., example 52) relates to a previous example (e.g., one of the examples 49 to 51) or to any other example, further comprising that the at least one semantic descriptor comprises a plurality of sets of bits, with each set of bits representing a number, wherein the decayed version is computed by applying a mathematical function to the number represented by the respective set of bits.

Another example (e.g., example 53) relates to a previous example (e.g., one of the examples 49 to 52) or to any other example, further comprising that the decayed version is based on an exponentially decaying version of semantic descriptors representing a plurality of previous states.

Another example (e.g., example 54) relates to a previous example (e.g., one of the examples 49 to 53) or to any other example, further comprising that the data structure comprises up to a predefined number of sets of semantic descriptors representing up to the predefined number of previous states of the set of data.

Another example (e.g., example 55) relates to a previous example (e.g., one of the examples 49 to 54) or to any other example, further comprising that the at least one semantic descriptor is based on metadata characterizing the set of data.

Another example (e.g., example 56) relates to a previous example (e.g., one of the examples 49 to 55) or to any other example, further comprising that the set of data relates to machine learning, wherein the at least one semantic descriptor represents at least one of a dataset version, a dataset size, a machine learning stack version, an augmentation profile, an optimizer used, or learning rate.

Another example (e.g., example 57) relates to a previous example (e.g., one of the examples 49 to 56) or to any other example, further comprising that the means for processing is to determine a content fingerprint of the current state of the set of data, and including the content fingerprint in the data structure.

Another example (e.g., example 58) relates to a previous example (e.g., example 57) or to any other example, further comprising that the content fingerprint is based on the SimHash algorithm.

Another example (e.g., example 59) relates to a previous example (e.g., one of the examples 49 to 58) or to any other example, further comprising that if the set of data is created by combining at least two sets of data that are associated with respective data structures, the means for processing is to combine the at least one semantic descriptor of the respective data structures to determine the at least one semantic descriptor for the set of data.

Another example (e.g., example 60) relates to a previous example (e.g., one of the examples 49 to 59) or to any other example, further comprising that the data structure has a fixed maximal size and a fixed number of semantic descriptors per state.

Another example (e.g., example 61) relates to a previous example (e.g., one of the examples 49 to 60) or to any other example, further comprising that the decayed version is calculated using a decay parameter.

Another example (e.g., example 62) relates to a previous example (e.g., example 61) or to any other example, further comprising that the decayed version of a semantic descriptor is calculated using (1−alpha)^{k}*Eₚᵣₑᵥᵢₒᵤₛ, where alpha is the decay parameter, k is the number of updates since the previous state, and Eₚᵣₑᵥᵢₒᵤₛ is the semantic descriptor included in the data structure for the previous state.

An example (e.g., example 63) relates to a device (20) for a computer system (100), the device (20) comprising memory (26), machine-readable instructions, and means for processing (24) to obtain a first data structure comprising at least one semantic descriptor characterizing a first state of a set of data, obtain a second data structure comprising at least one semantic descriptor characterizing a second state of the set of data, wherein the at least one semantic descriptor characterizing the second state of the set of data is based on a decayed version of the at least one semantic descriptor characterizing the first state of the set of data, and determine a lineage between the first state and the second state of the set of data based on the at least one semantic descriptor.

Another example (e.g., example 64) relates to a previous example (e.g., one of the examples 33 to 47) or to any other example, further comprising that the respective data structures are determined or updated using the device of at least one of the examples 33 to 47.

Another example (e.g., example 65) relates to a computer system (100) configured to perform at least one of the method of one of the examples 17 to 30 or the method of one of the examples 31 or 32.

Another example (e.g., example 66) relates to a computer system (100) comprising at least one of the apparatus according to one of the examples 33 to 46 or the apparatus according to one of the examples 47 or 48.

Another example (e.g., example 67) relates to a computer system (100) comprising at least one of the device according to one of the examples 49 to 62 or the device according to one of the examples 63 or 64.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for a computer system, the method comprising:
obtaining a set of data;
determining at least one semantic descriptor characterizing a current state of the set of data;
determining whether the set of data is associated with a data structure comprising at least one semantic descriptor characterizing a previous state of the set of data;
in response to a negative determination, creating a new data structure comprising the determined at least one semantic descriptor characterizing the current state of the set of data;
in response to a positive determination, computing a combination of (i) a decayed version of the at least one semantic descriptor characterizing the previous state of the set of data and (ii) the at least one semantic descriptor characterizing the current state of the set of data, and updating the data structure based on the combination.

2. The non-transitory computer-readable medium according to claim 1, wherein the at least one descriptor comprises a composite descriptor that is based on a plurality of semantic descriptors that respectively characterize a plurality of aspects of the state of the set of data.

3. The non-transitory computer-readable medium according to claim 2, wherein the composite descriptor is determined such that the impact of the individual semantic descriptors of the plurality of semantic descriptors is dispersed across the composite descriptor.

4. The non-transitory computer-readable medium according to claim 1, wherein the at least one semantic descriptor comprises a plurality of sets of bits, with each set of bits representing a number, wherein the decayed version is computed by applying a mathematical function to the number represented by the respective set of bits.

5. The non-transitory computer-readable medium according to claim 1, wherein the decayed version is based on an exponentially decaying version of semantic descriptors representing a plurality of previous states.

6. The non-transitory computer-readable medium according to claim 1, wherein the data structure comprises up to a predefined number of sets of semantic descriptors representing up to the predefined number of previous states of the set of data.

7. The non-transitory computer-readable medium according to claim 1, wherein the at least one semantic descriptor is based on metadata characterizing the set of data.

8. The non-transitory computer-readable medium according to claim 1, wherein the set of data relates to machine learning, wherein the at least one semantic descriptor represents at least one of a dataset version, a dataset size, a machine learning stack version, an augmentation profile, an optimizer used, or a learning rate.

9. The non-transitory computer-readable medium according to claim 1, wherein the method further comprises determining (125) a content fingerprint of the current state of the set of data, and including the content fingerprint in the data structure.

10. The non-transitory computer-readable medium according to claim 9, wherein the content fingerprint is based on the SimHash algorithm.

11. The non-transitory computer-readable medium according to claim 1, wherein, if the set of data is created by combining at least two sets of data that are associated with respective data structures, the method comprises combining (140) the at least one semantic descriptor of the respective data structures to determine the at least one semantic descriptor for the set of data.

12. The non-transitory computer-readable medium according to claim 1, wherein the data structure has a fixed maximal size and a fixed number of semantic descriptors per state.

13. The non-transitory computer-readable medium according to claim 1, wherein the decayed version is calculated using a decay parameter.

14. The non-transitory computer-readable medium according to claim 13, wherein the decayed version of a semantic descriptor is calculated using (1−alpha)\hat{ }k*Eₚᵣₑᵥᵢₒᵤₛ, where alpha is the decay parameter, k is the number of updates since the previous state, and Eₚᵣₑᵥᵢₒᵤₛ is the semantic descriptor included in the data structure for the previous state.

15. A non-transitory computer-readable medium storing instructions that, when executed by one or more processing circuitries, cause the one or more processing circuitries to perform a method for a computer system, the method comprising:
obtaining (210) a first data structure comprising at least one semantic descriptor characterizing a first state of a set of data;
obtaining (220) a second data structure comprising at least one semantic descriptor characterizing a second state of the set of data,
wherein the at least one semantic descriptor characterizing the second state of the set of data is based on a decayed version of the at least one semantic descriptor characterizing the first state of the set of data; and
determining (230) a lineage between the first state and the second state of the set of data based on the at least one semantic descriptor.

16. A non-transitory computer-readable medium according to claim 15, wherein the respective data structures are determined or updated using the method of at least claim 1.

17. An apparatus (10) for a computer system (100), the apparatus (10) comprising memory or storage circuitry (16), machine-readable instructions, and processor circuitry (14) to execute the machine-readable instructions to:
obtain a set of data;
determine at least one semantic descriptor characterizing a current state of the set of data;
determine whether the set of data is associated with a data structure comprising at least one semantic descriptor characterizing a previous state of the set of data;
in response to a negative determination, create a new data structure comprising the determined at least one semantic descriptor characterizing the current state of the set of data;
in response to a positive determination, compute a combination of (i) a decayed version of the at least one semantic descriptor characterizing the previous state of the set of data and (ii) the at least one semantic descriptor characterizing the current state of the set of data, and update the data structure based on the combination.

18. The apparatus according to claim 17, wherein the at least one descriptor comprises a composite descriptor that is based on a plurality of semantic descriptors that respectively characterize a plurality of aspects of the state of the set of data.

19. The apparatus according to claim 17, wherein the composite descriptor is determined such that the impact of the individual semantic descriptors of the plurality of semantic descriptors is dispersed across the composite descriptor.

20. The apparatus according to claim 17, wherein the at least one semantic descriptor comprises a plurality of sets of bits, with each set of bits representing a number, wherein the decayed version is computed by applying a mathematical function to the number represented by the respective set of bits.
